(19) United States
(12) Patent Application Publication
(10) Pub. No.: US 2002/0091770 A1
(43) Pub. Date: Jul. 11, 2002

(54) Method of and system for communication, communication information-processing unit, information terminal, and computer product

(76) Inventors: Tetsuo Takakura, Tokyo (JP); Masaomi Sato, Tokyo (JP); Tsuyoshi Ishida, Tokyo (JP)

Correspondence Address: LOWE HAUPTMAN GILMAN & BERNER, LLP, Suite 310, 1700 Diagonal Road, Alexandria, VA, 22314, US

(21) Appl. No.: 10/013,935

(22) Filed: Dec. 13, 2001

(30) Foreign Application Priority Data
Dec. 14, 2000 (JP) 2000-381028

(51) Int. Cl. G06F 15/16

(52) U.S. Cl. 709/205

(57) ABSTRACT

An input format is transmitted to a client device of a user. The user fills his own information in the input format. The input information is transmitted to a server device. The server device creates the user's home page based on the user's information. Users who pay a particular amount of money are allowed to update their homepages.

### FIELD OF THE INVENTION

The present invention relates to a method of and system for communication which allows to automatically create a homepage (i.e., webpage). This invention also relates to a communication information-processing unit, an information terminal, and a computer product.

### BACKGROUND OF THE INVENTION

With recent development of the Internet technology, communication systems have been wide spread for enabling communication between a plurality of people, using the Internet. General communication systems using the Internet include WWW (World Wide Web) in which a Web page (i.e. a homepage (HP) or a webpage) stored in a server device is accessed by using an access software (i.e., a browser software) of a client device, electronic mails for electronically distributing character data, image data and the like via the server device, and chat in which a plurality of people can write sentences or the like in an interactive mode, in a Web page stored in the server device.

However, there is a problem in that users of the WWW, E-mail or chat cannot release his/her profile information or the like easily in the homepage. That is to say, users of the Internet need to acquire expertise, design or the like of HTML, in order to create own HP. There are websites that support the users in creating an launching a homepage, but users still have to bear a large burden.

Also, when readers of WWW or practicing of the chat communicate with each other on the communication system, there is a problem in that the profile or the like of the opponent cannot be read easily. That is to say, even if user releases own HP on the Internet, there is no intimate cooperation relationship between the user's HP and the communication system, and hence it is not convenient for users.

As described above, the conventional system has various problems, and as a result, the system has been inconvenient and less efficient to users of the communication system.

The related art and problems to be solved by the present invention described above are not limited to the communication system, in which WWW, e-mail or chat can be used, and it can be similarly considered in all systems in which user's communication is made possible by other unit.

### SUMMARY OF THE INVENTION

It is an object of the present invention to provide a method of and system for communication in which users can release own profile information or the like easily in the form of homepage. It is another object of this invention to provide a communication information-processing unit, an information terminal, and a computer-readable recording medium that stores a computer program for realizing the method according to the present invention on a computer.

The communication system according to one aspect of the present invention comprises a communication information-processing unit, and a plurality of information terminal connected to the communication information-processing unit via a network. The users of the information terminals communicate with each other. The communication information-processing unit includes an input format transmission unit which transmits, to a particular one of the information terminal, an input format for inputting user information related to the user of the particular information terminal, and a homepage creation unit which creates a homepage of the user of the particular information terminal based on the user information received from the particular information terminal. Each one of the information terminals includes an input display unit which displays an input area for inputting the user information in the input format received from the communication information-processing unit.

According to the above-mentioned aspect, the input format for inputting the user information related to the user is transmitted to the information terminal, and user's homepage is created according to the user information transmitted from the information terminal. Hence, the user can easily release the own profile information or the like in the homepage.

The communication information-processing unit according to another aspect of the present invention is part of a communication system in which the communication information-processing unit is connected to a plurality of information terminals via a network. The users of the information terminals communicate with each other via the network. The communication information-processing unit comprises an input format transmission unit which transmits, to a particular one of the information terminal, an input format for inputting user information related to the user of the particular information terminal, and a homepage creation unit which creates a homepage of the user of the particular information terminal based on the user information received from the particular information terminal.

According to the above-mentioned aspect, the input format for inputting user information related to the user is transmitted to the information terminal, and the homepage of the user is created according to the user information transmitted from the information terminal. Hence, the user can easily release the own profile information or the like in the homepage.

The information terminal according to still another aspect of the present invention is part of a communication system in which a communication information-processing unit is connected to a plurality of the information terminals via a network. The users of the information terminals communicate with each other via the network. The information terminal comprising an input display unit which displays an input area for inputting the user information in an input format received from the communication information-processing unit, and a transmission unit which transmits the user information, input by the user in the input area displayed by the input display unit, to the communication information-processing unit.

According to the above-mentioned aspect, when the input format for inputting user information related to the user is transmitted from the communication information-processing unit, the input area of the user information is displayed based on the input format, and the user information input by the user, using the input display unit, is transmitted to the communication information-processing unit. Hence, the user can release the own profile information or the like easily in the homepage.

The communication method according to still another aspect of the present invention is a method by which users of a plurality of information terminals communicate with each other via a communication information-processing unit connected to a network. In this communication method the communication information-processing unit executes transmitting, to a particular one of the information terminal, an input format for inputting user information related to the user of the particular information terminal, and creating a homepage of the user of the particular information terminal based on the user information received from the particular information terminal.

According to the above-mentioned aspect, the input format for inputting user information related to the user is transmitted to the information terminal, and the user's homepage is created in accordance with the user information transmitted from the information terminal. Hence, the user can easily release the own profile information in the homepage.

The computer-readable recording medium according to another aspect of the present invention stores a computer program which when executed realizes the method according to the present invention.

Other objects and features of this invention will become apparent from the following description with reference to the accompanying drawings.

### BRIEF DESCRIPTION OF THE DRAWINGS

FIG. 1 is a block diagram that shows the configuration of the communication system according to the present invention.

FIG. 2 shows in detail a configuration of a server device 1 shown in FIG. 1.

FIG. 3 shows in detail a configuration of a client device 3 shown in FIG. 1.

FIG. 4 is a flowchart that shows the various steps involved when issuing a communication ID (“process of issue of a communication ID”).

FIG. 5 is a flowchart that shows the various steps involved when logging-on (“log-on processing”).

FIG. 6 is a flowchart that shows the various steps involved when creating a homepage (“homepage creation processing”).

FIG. 7 is a flowchart that shows the various steps involved when searching a desired homepage (“homepage search processing”).

FIG. 8 is a flowchart that shows the various steps involved when automatically creating a homepage (“homepage automatic creation processing”).

FIG. 9 is a flowchart that shows the various steps involved when automatically modifying (i.e., updating) a homepage (“homepage automatic modification processing”).

FIG. 10 is a flowchart that shows the various steps involved when displaying an on-line URL locate page (“display processing of an on-line URL locate page”).

FIG. 11 is a flowchart that shows the various steps involved when creating and updating a WWW URL locates list (“creation and update processing of a WWW URL locates list”).

FIG. 12 is a flowchart that shows the various steps involved when creating or updating a friend list or a rejection list (“creation and update processing of a friend list or a rejection list”).

FIG. 13 is a flowchart that shows the various steps involved when establishing a friend chat (“establishment processing of a friend chat”).

FIG. 14 is a flowchart that shows the various steps involved when executing a PB message (“execution processing of a PB message”).

FIG. 15 is a diagram showing one example of a display screen of a Web page for requesting an issue of a communication ID, displayed on a display of a client device 3.

FIG. 16 is a diagram showing one example of a display screen of an input page for inputting information necessary for setting the communication ID, displayed on the display of the client device 3.

FIG. 17 is a diagram showing one example of a display screen of a Web page for notifying the communication ID, displayed on the display of the client device 3.

FIG. 18 is a diagram showing one example of a display screen of an initial page displayed on the display of the client device 3.

FIG. 19 is a diagram showing one example of a display screen of a user control information setting page displayed on the display of the client device 3.

FIG. 20 is a diagram showing one example of a display screen of a registration completion notification page displayed on the display of the client device 3.

FIG. 21 is a diagram showing one example of a display screen of a homepage creation page displayed on the display of the client device 3.

FIG. 22 is a diagram showing one example of a display screen of a homepage creation page displayed on the display of the client device 3.

FIG. 23 is a diagram showing one example of a display screen of a homepage confirmation page displayed on the display of the client device 3.

FIG. 24 is a diagram showing one example of a display screen of a homepage search page displayed on the display of the client device 3.

FIG. 25 is a diagram showing one example of a display screen of a search result page displayed on the display of the client device 3.

FIG. 26 is a diagram showing one example of a display screen of a user's homepage displayed on the display of the client device 3.

FIG. 27 is a diagram showing one example of a display screen of a Web page displayed on the display of the client device 3.

FIG. 28 is a diagram showing one example of a display screen of a Web page displayed on the display of the client device 3.

FIG. 29 is a diagram showing a display example of an inquiry page and a PB message page.

### DETAILED DESCRIPTIONS

Embodiments of the method of and the system for communication, communication information-processing unit, information terminal, and the computer-readable recording medium according to the present invention will now be described in detail with reference to the accompanying drawings. However, the present invention is not limited to these embodiments.

In particular, in the embodiments described below, as an example, the present invention is applied to a communication system which can utilize WWW, e-mails and chat, but the present invention is not limited to this example, and may be similarly applied to all systems which can make user communication possible by other unit.

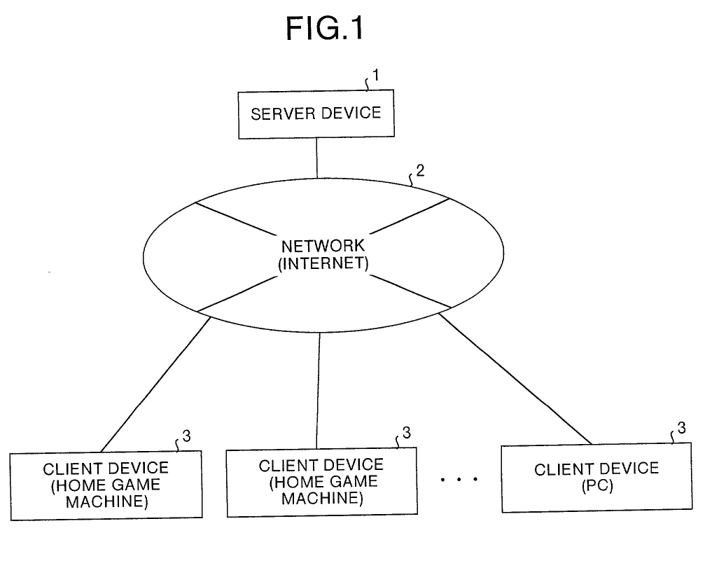

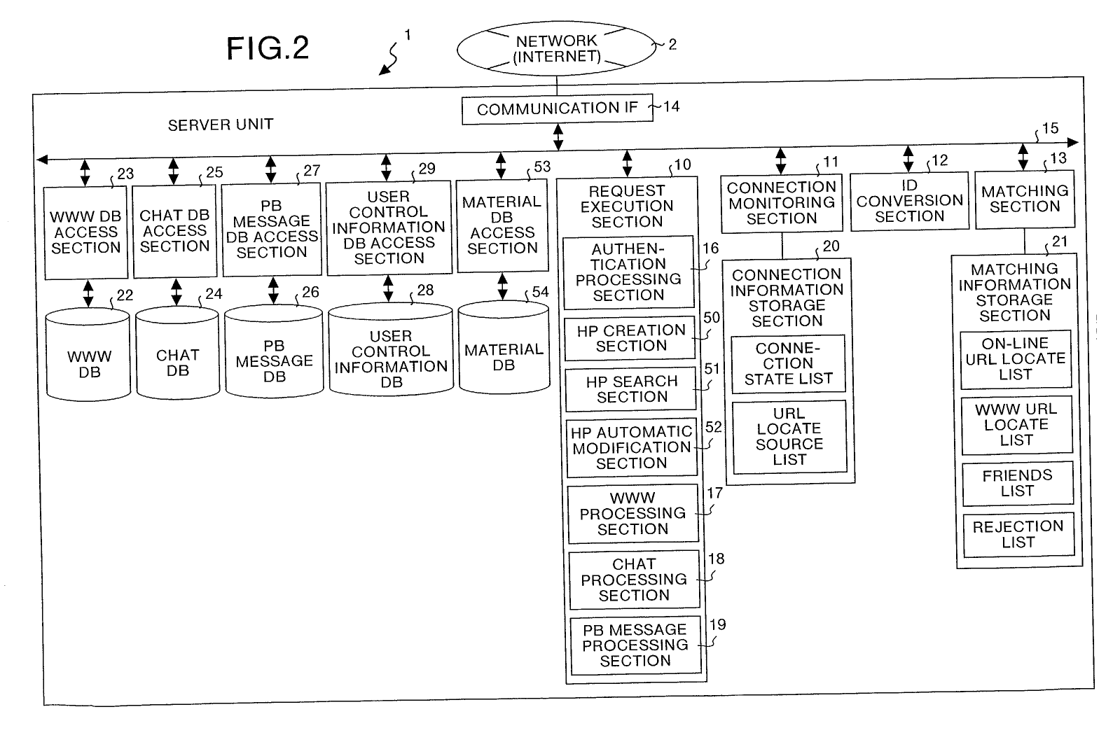

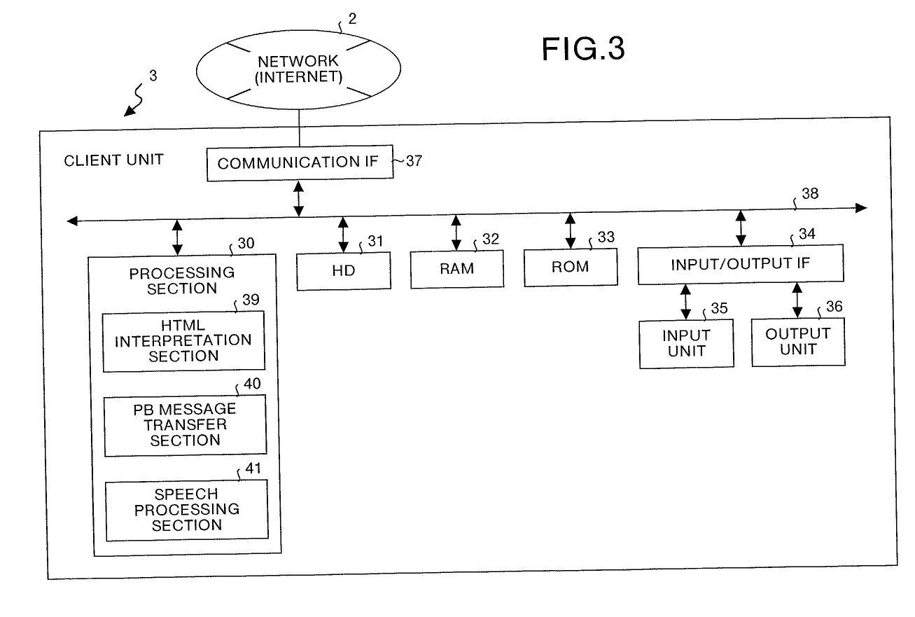

FIG. 1 is a block diagram that shows the configuration of the communication system according to the present invention. FIG. 2 shows in detail a configuration of a server device 1 shown in FIG. 1. FIG. 3 shows in detail a configuration of a client device 3 shown in FIG. 1.

As shown in FIG. 1, in the communication system (“this system”) according to one embodiment, at least one server device 1 and a plurality of client devices 3 are connected to each other via a network 2 in such a manner that the server device 1 and the client devices 3 can freely communicate (transfer and receive data) with each other. Hereinafter, the summary of the services provided by this system will be described, and thereafter, the construction of this system and the processing thereof will be described in detail.

Summary of the Services,

In this system, the user of each client device 3 can use various services for communicating with other users. This system can also automatically generate a homepage from the user control information or the like which has been registered by the user at the time of joining the service, and release this homepage in association with various services. Also, by making an agreement for pay service or the like, the contents of the created homepage can be updated. Moreover, the created homepage is automatically modified according to a predetermined condition.

The main services provided by this system include WWW, chat and private message (PB message). Also, as auxiliary services for smoothly performing these services, there can be used profile reference, an on-line URL locate list, a WWW URL locate list, a friends list and a rejection list. These respective services can be performed separately, or it is also possible to use a plurality of services simultaneously or synchronously on the same screen.

As described below, this system can organically connect these various services with user's homepages. That is to say, users of various services can create their own homepage with a simple operation, and the created homepage can be properly displayed, according to need, at the time of executing various services.

In the main services, the “WWW” is basically a service in which Web pages stored in this system or in an external server can be accessed by the client device 3, as in the conventional service.

The “chat” is a service for users to have a talk with each other in a virtual chat room. Particularly, in this system, there is a feature that the chat room can be established actively with respect to other users, in addition to the function as the conventional common chat.

The “PB message” is for a user to transmit a message individually with respect to other users. Particularly, compared to the conventional e-mails, it has such a feature that it is based on real time, and users can transmit messages actively to other users.

Furthermore, in the auxiliary services, the “profile reference” stands for a service in which users of each client device 3 can register their own profiles in the server device 1, and other users can refer to these profiles according to need. Each user can refer to these profiles for assistance at the time of creating a friends list or a rejection list described below.

The “on-line URL locate list” is a service for notifying each user of the existence of other users who are now on-line to this system.

The “WWW URL locate list” is a service for notifying each user who is using the WWW service of the existence of other users who are now accessing the same Web page.

Each user can easily search other users having the same taste, by referring to these on-line URL locate list and WWW URL locate list, and can use these at the time of creating the friends list or the rejection list described below.

The “friends list” is a service in which each user can register other users as his/her friends in the server device 1. This “friends list” can be referred to at the time of selecting the transmission destination in the chat service or in the PB message service, thereby circle of communication can be expanded, as well as making selection operation easy.

The “rejection list” is a service in which each user can register other users in the server device 1, as users with whom he/she does not want to communicate (a user to be rejected). Where there is a request for joining the chat or a PB message is transmitted from the user to be rejected registered in this rejection list, these communication requests can be automatically rejected.

A) System Construction,

Details of the configuration of the server device 1 will now be described. As shown in FIG. 2, the server device 1 schematically comprises a request execution section 10, a connection monitoring section 11, an ID conversion section 12, a matching section 13, a plurality of database system and a communication interface (communication IF) 14, and these respective sections are connected via a communication path 15 such as a network and a bus, so as to be able to communicate. This server device 1 is further connected to a network 2 via a communication apparatus (not shown) such as router and a dedicated line, so as tobe able to communicate with each other.

The request execution section 10 executes various services requests from the client device 3. The request execution section 10 includes an authentication processing section 16 for performing processing such as authentication when a user logs in to this system, and judgment of availability at the time of using each service, a homepage creation section 50 for automatically creating a homepage from the user's profile or the like, a homepage search section 51 for searching homepages of other users, a homepage automatic modification section 52 for automatically modifying the homepage of the user according to a predetermined condition, a WWW processing section 17 for performing processing related to WWW, a chat processing section 18 for performing processing related to the chat, and a PB message processing section 19 for performing processing related to the PB message.

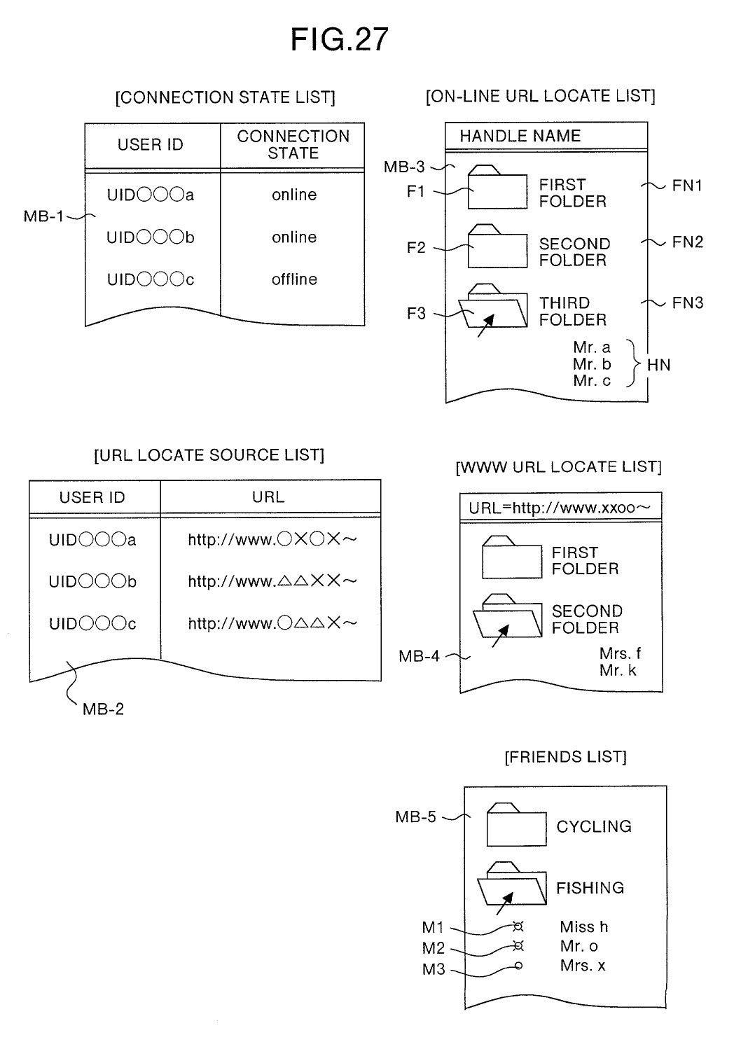

The connection monitoring section 11 monitors the connection state of each client device 3. Specifically, the connection monitoring section 11 monitors, at a predetermined interval, the connection-established state of each client device 3, and the URL (Uniform Resource Locator) of the Web page transmitted lastly to each client device 3. The connection-established state obtained by this monitoring is temporarily stored in the connection information storage section 20, as a connection state list, and the obtained URL is stored as an URL locate source list, respectively. In FIG. 27, MB-1 is an example of the contents of the connection state list. This connection state list is composed of user ID's, and the connection states (online or offline) of each user. The connection state can be obtained from an associated ISP described later. In FIG. 27, MB-2 is an example of the contents of the URL locate source list. This URL locate source list is composed of user ID's, and a URL of a Web page transmitted lastly to each user. The Web page URL stored in the server device 1 outside of this system can be obtained from this external server device 1, upon approval of this external server device 1.

The ID conversion section 12 converts the user ID or communication ID described later and the handle name described later, to each other, as required. By this conversion, only the handle names of other users are displayed to each user, to thereby prevent the user ID or communication ID from being leaked improvidently.

The matching section 13 performs creation and update of the on-line URL locate list, the WWW URL locate list, the friends list and the rejection list, based on the information obtained from each section of the server device 1. The on-line URL locate list and the WWW URL locate list are created and updated based on the URL locate source list stored in the connection information storage section 20. Also, the friends list and the rejection list are respectively created and updated based on the friends information and the information of persons to be rejected stored in the user control information database 28 described later. The specific contents of these respective lists will be described later. Each list thus created is temporality stored in the matching information storage section 21. The matching section 13 has aligning and hierarchical functions so that each list can be easily used, which will be described later.

Each database system of the server device 1 will be described. These respective database systems are constituted, respectively, by mixing database (DB) for storing various data, and a database access section (DB access section) as a DBMS (Database Management System) for performing database control such as write and read (information operation) with respect to the database.

Specifically, there are provided WWW database 22 for storing a plurality of Web pages and a WWW database access section 23 for performing information operation with respect to the WWW database 22. As this Web page, there can be mentioned, for example, the initial page of this system, a page becoming a base for referring to the user information, or a page becoming a base for a chat room page or the like, and a homepage of the user. These Web pages are formed as an HTML (Hypertext Markup Language) source code beforehand or according to need, and stored in the WWW database 22. The Web page is not limited to a so-called static page, and according to need, can be constructed as a dynamic page including script codes described by Perl or the like for achieving CGI (Common Gateway Interface), or Java script codes. The interpretation and execution of these script codes are performed in the above-described WWW processing section 17.

As the database system, there are provided material database 54 for storing information related to the materials of the homepage to be created, and a material database access section 53 for performing information operation with respect to the material database 54. Here, the information related to the material stands for, for example, design data for decorating the homepage, fortune-telling data such as constellation and blood type, homepage data for predetermined events such as birthday, wedding anniversary, etc., link information of Web sites related to the user control information, and text data, image data or speech data to become materials at the time of creating the homepage.

As the database system, there are also provided chat database 24 for storing information related to the chat, and a chat database access section 25 for performing information operation with respect to the chat database 24. Here, the information related to the chat includes, for example, status information indicating the established state of the chat room, a room ID added for each chat room, and a room Key required for joining the chat room, these being stored in the chat database 24, associated with each other. The information related to the chat is dynamically generated and updated, according to need.

As the database system, there are also provided PB message database 26 for storing information related to the PB message, and a PB message database access section 27 for performing information operation with respect to the PB message database 26. Here, the information related to the PB message includes, for example, the sender, the receiver and the contents of the PB message transmitted via the client device 3, or the presence of reception of this message, these being stored in the PB message database 26, associated with each other. The information related to the PB message is also dynamically generated and updated, according to need.

User control information database 28 for storing the user control information and a user control information database access section 29 for performing information operation with respect to the user control information database 28 are also provided. Here, the user control information includes, information related to the user profile, for example, user ID, password, communication ID (comm ID), nickname (handle name) of each user on this system, gender, occupation, constellation, age, blood type, birthday, hobbies, special skill, address, region where the user lives (for example, country name, name of a prefecture, etc.), genre in which the user has an interest (for example, shopping, music, bond and finance, news, computer, etc.), hobbies, URL of own homepage or homepage name, and twelve signs of the Oriental Zodiac, friends information, rejection information, list of disabled users, game history information related to the user's game history (for example, game name, number of stages, play result, score, time, etc.), information related to the genre of favorite games (for example, sports game, simulation game, fighting game, race game, etc.), and information related to characters in the favorite game. Particularly, these are not limited to the text data, and binary data such as images and speech can be stored. Moreover, registration can be done at an optional timing after each user joins this system, and may be edited as required.

The “user ID” is identification information (first identification information) provided to a user from an ISP (Internet Service Provider) for identifying the user uniquely, when each user makes an agreement with the ISP for using the line to connect the own client device 3 to the Internet. Also, at this time, each user registers an optional password that can be known by only the user and the ISP. As the ISP, an ISP who cooperates with this system (cooperated ISP) for providing predetermined information to this system is used.

The “communication ID” is the identification information (second identification information) provided from the server device 1 to the user, for identifying the user uniquely in this system, when each user joins this system.

The “friends information” is the information for uniquely specifying other users registered as friends by each user. Also, the rejection information is the information for uniquely specifying other users registered as a person to be rejected by each user. Specifically, these friends information and rejection information are constituted by using the above-described user ID.

The “list of disabled users” is a list for uniquely specifying a disabled person, in the case where there is a user who has taken undesirable action legally or ethically in this system, or there is a user who should be prohibited for using this system due to other optional reasons, in order to prohibit such a user (disabled user) from using this system. This list of disabled users is constituted by using the user ID of the disabled user, and is stored at an optional timing by the administrator of this system.

Detail configuration of the client device 3 will now be described. This client device 3 schematically comprises, as shown in FIG. 3, a processing section 30, an HD 31, a RAM32, a ROM (Read Only Memory) 33, an input/output interface (input/output IF) 34, an input unit 35, an output unit 36 and a communication IF 37, and each section is connected so as to be able to communicate with each other via a bus 38. This client device 3 can be realized by, for example, a personal computer or a game machine for home or for business, with a part of the functions being specialized into a game.

The processing section 30 of this client device 3 comprises an HTML interpretation section 39 for performing interpretation of HTML sentences, a PB message transfer section 40 for performing processing related to the transfer of the PB message, and a speech processing section 41 for performing speech processing. The processing contents of these sections will be described later.

The construction of the network 2 will now be described. The network 2 has a function for connecting the server device 1 and the client device 3 with each other. The network 2 is, for example, the Internet or the like.

B) Processing Carried Out in Providing the Services,

Specific processing of each service provided in this system constructed in this manner will be described. The processing of each service will be described individually below, but these services can be performed in series. The order for performing each service is not limited to the one described below, and can be performed in an optional order.

a) User Authentication

i) Issue of User ID,

The processing for performing user authentication will be described.

When the user makes an agreement for using the line with a cooperated ISP, a user ID is issued from this cooperated ISP to the user. At the same time, the user registers an optional password. Issue of the user ID and registration of the password can be performed in the conventional manner. These user ID and password are provided beforehand to the server device 1 in this system from the cooperated ISP, and stored in the user control information database 28 related to each other, via the user control information database access section 29 (hereinafter, the description of each access section 23, 25, 27, 29 and 53 at the time of performing the information operation of each database 22, 24, 26, 28 and 54 is omitted). The meaning that the user ID has in this system will be described later.

ii) Issue of Communication ID,

When the user accesses the server device 1 for the first time, the user makes an agreement for joining this system. At this time, a communication ID is granted from the server device 1 to the user.

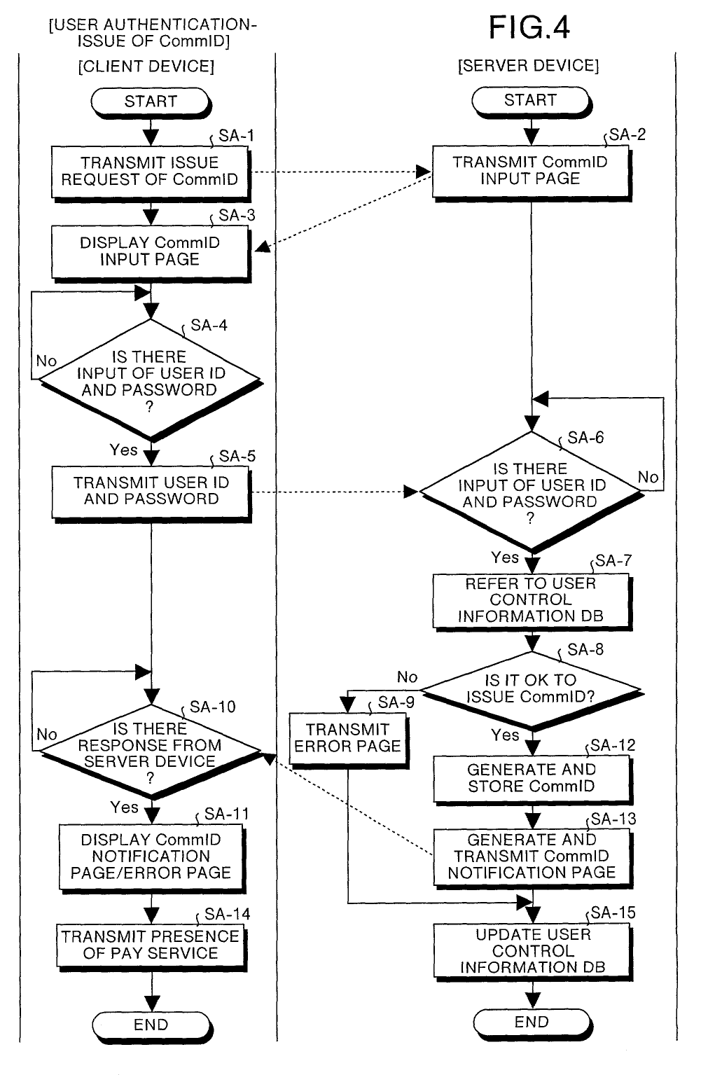

FIG. 4 is a flowchart showing the processing for issuing the communication ID. In this FIG. 4, when a user of the client device 3 requests an issue of the communication ID via the input unit 35, this issue request is transmitted to the server 1 (step SA-1). The server device 1 having received this request transmits an input page for inputting the information necessary for setting the communication ID to the client device 3 (step SA-2).

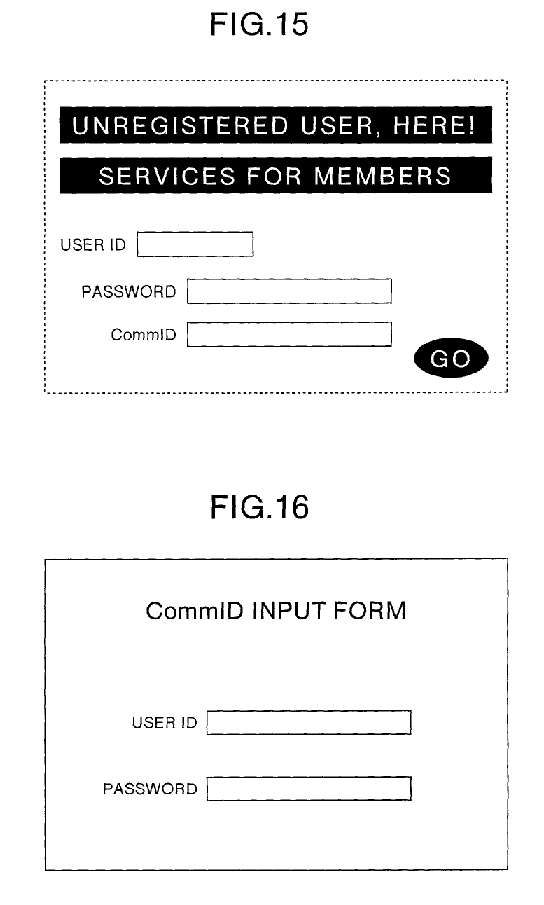

FIG. 15 is a diagram showing one example of the display screen of a Webpage for requesting an issue of a communication ID, displayed on a display of the client device 3, and FIG. 16 is a diagram showing one example of the display screen of an input page for inputting information necessary for setting the communication ID, displayed on the display of the client device 3. In the client device 3 having received this transmission, the HTML source code is interpreted by the HTML interpretation section 39, and the input page is displayed on the monitor according to this interpretation result (step SA-3). The respective processing of extraction, formation, transmission and interpretation of the HTML source code is similar to the processing described below, except of a specially mentioned case, and hence the individual description thereof is omitted.

In the input page displayed on the monitor in this manner, an input of at least the user ID and password is urged. When these are input in the input page, these are transmitted to the server device 1 (steps SA-4, SA-5). In the authentication processing section 16 of the server device 1, it is judged whether a communication ID is to be granted or not, based on the transmitted user ID and password, referring to the user control information database 28 (steps SA-6 to SA-8). Here, as a case where the grant of the communication ID is rejected, there can be mentioned, for example, a case where the transmitted user ID and password are not stored in the user control information database 28, or a case where a communication ID has been already issued with respect to the transmitted user ID. In such a case, a predetermined error page is extracted from the WWW database 22 and transmitted to the client device 3 (step SA-9), and this error page is displayed on the monitor of the client device 3 (steps SA-10, SA-11).

On the other hand, in the case where there is no reason of rejecting the grant of the communication ID in step SA-8, a communication ID is generated at random in the authentication processing section 16. This communication ID is stored in the user control information database 28, associated with the already transmitted user ID or the like (step SA-12). Also, a notification page for notifying this communication ID is generated, and transmitted to the client device 3 and displayed (steps SA-13, SA-10, SA-11). The formation of this notification page is performed in such a manner that an original Web page is extracted from the WWW database 22, a communication ID is added to this page, to form a new Web page. As a result, the communication ID is notified to the user.

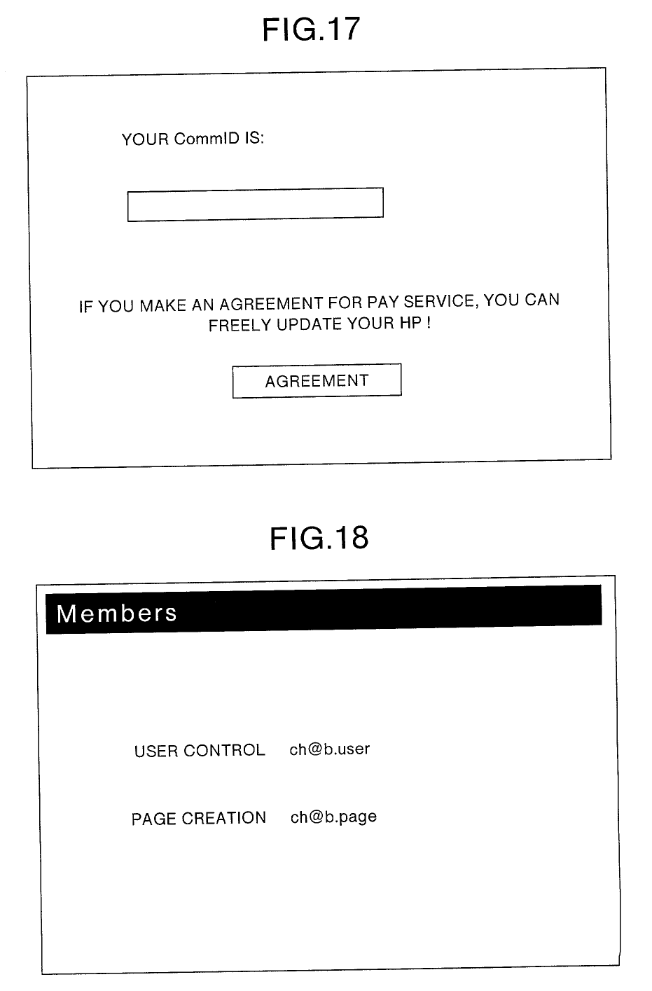

FIG. 17 is a diagram showing one example of the display screen of a Web page for notifying the communication ID, displayed on the display of the client device 3. By this display screen, the communication ID is notified, and a button for making an agreement for the pay service for performing update of the own homepage is displayed. When the user clicks this button, the client device 3 transmits this matter to the server device 1 (step SA-14). The server device 1 stores the existence of the pay service in the user control information database 28 (step SA-15).

iii) Log On,

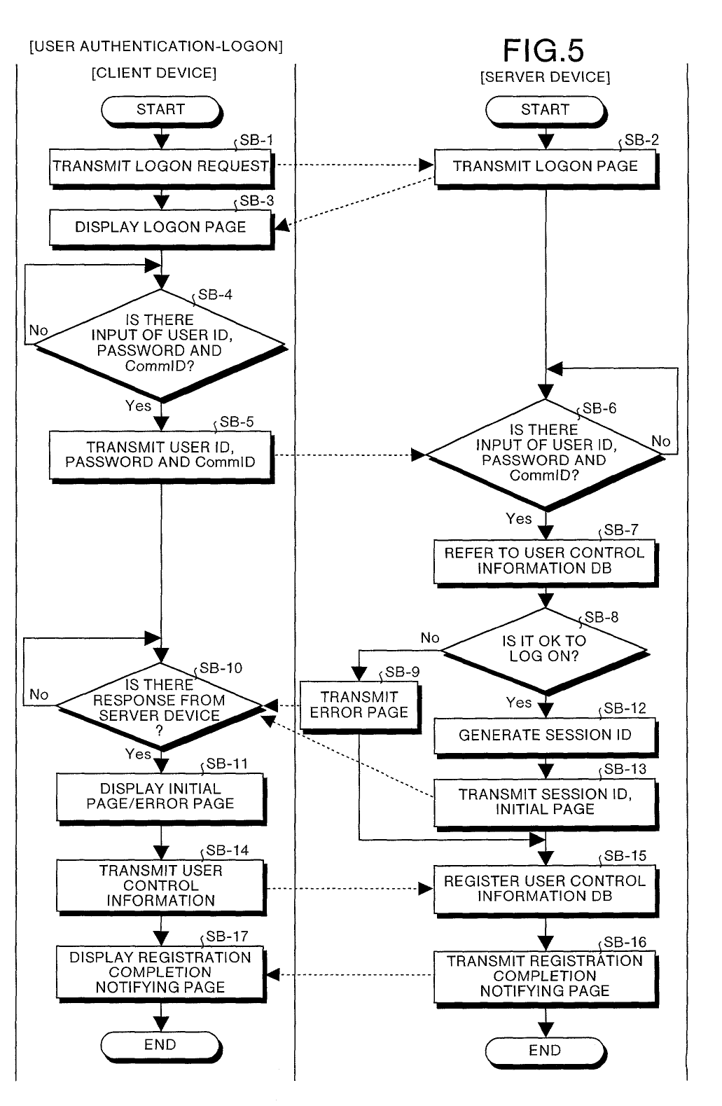

The user having the communication ID issued in this manner can log on this system, using this communication ID. FIG. 5 is a flowchart showing the log-on processing. In this FIG. 5, when a log-on request is transmitted from the user (step SB-1), in the server device 1, a log-on page is extracted from the WWW database 22 by the processing of the authentication processing section 16, and this log-on page is transmitted to the client device 3 and displayed (steps SB-2, SB-3). FIG. 15 shows one example of the log-on page. In this log-on page, the user inputs and transmits the user ID, the password and the communication ID (steps SB-4, SB-5).

In the authentication processing section 16 of the server device 1, it is judged whether logon is to be allowed or not, based on the transmitted user ID, password and communication ID, referring to the user control information database 28 (steps SB-6 to SB-8). Here, as a case where the logon is rejected, there can be mentioned, for example, a case where either one of the input user ID, password and communication ID does not agree with the contents stored in the user control information database 28, and a case where the input user ID corresponds to the one in the list of disabled users in the user control information database 28. In such a case, the error page is transmitted to the client device 3 and displayed on the monitor (steps SB-9 to SB-11).

On the other hand, in the case where there is no reason of rejecting the logon in step SB-8, a session ID is issued in the authentication processing section 16 (step SB-12), and an initial page is extracted from the WWW database 22 (step SB-13). These session ID and initial page P1 are transmitted to the client device 3 and the initial page is displayed on the monitor (step SB-11). FIG. 18 is a diagram showing one example of the display screen of the initial page displayed on the display of the client device 3. In the example shown in this figure, the initial page is constituted of a button for selecting “user control” or “page creation”, but this initial page can be constituted of optional contents, or the initial page may be omitted and other service pages described later may be displayed. The “session ID” issued in the above-described step SB-12 is continuously used until log out from this system, and is transmitted every time some request is made from the client device 3 to the server device 1, and used for confirming the authentication condition of the client device 3. Hereinafter, the transfer processing of this session ID is omitted.

When a user specifies user control in the initial page, the setting page of the user control information is transmitted from the server device 1 to the client device 3. Thereby, the user sets the user control information from the client device 3 (step SB-14). What is input in this stage is a part of information of user control information such as comprehensive items, and detailed user control information is input at the time of creating a homepage. By registering the user control information stepwise, weighting of the user control information to be registered can be performed, and more important information can be registered in the server device 1 early and reliably. Moreover, since the detailed information is registered later, user registration can be performed with a simple content, and hence user registration can be promoted.

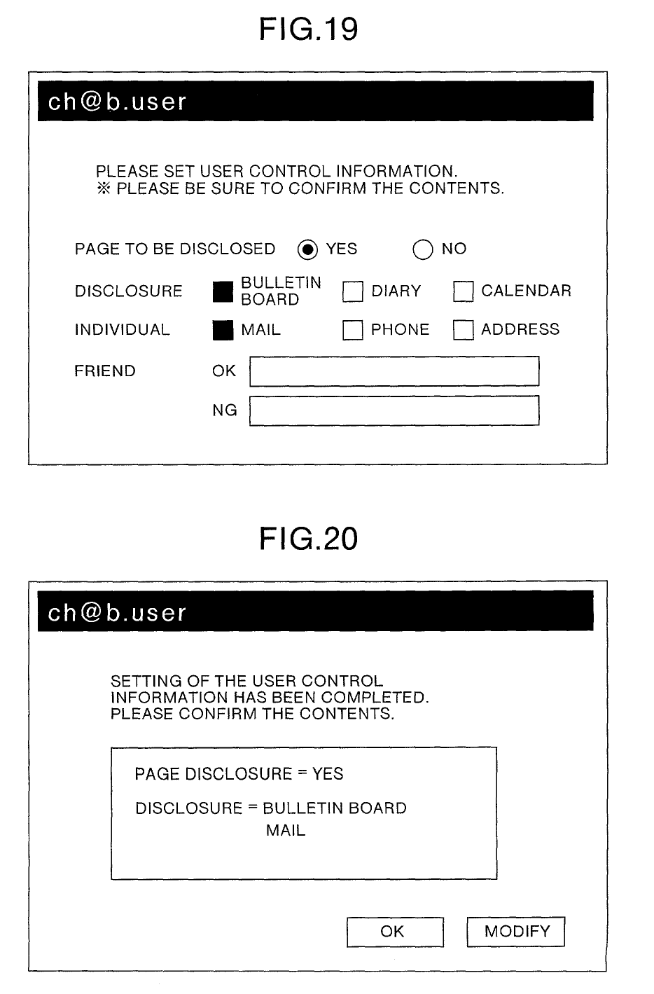

FIG. 19 is a diagram showing one example of the display screen of a user control information setting page displayed on the display of the client device 3. Of the user control information, the user inputs presence of a homepage, contents disclosed in the homepage (bulletin board, diary, calendar, etc.), personal information disclosed in the homepage (mail address, telephone number, address, etc.), and users to be registered as friends or as a user to be rejected, using this screen. The client device 3 transmits the input user control information to the server 1 (step SB-14).

The server device 1 registers the received user control information in the user control information database 28 (step SB-15). Then, the user creates a registration completion-notifying page based on this registered content, and transmits it to the client device 3 (step SB-16). The client device 3 displays the received registration completion-notifying page on the display (step SB-17).

FIG. 20 is a diagram showing one example of the display screen of the registration completion-notifying page displayed on the display of the client device 3. The user confirms the registered content by the registration completion-notifying page. In the case where the user wants to modify the content, by clicking the “modify” button, the user control information setting screen is again displayed, and the user can input the user control information. Moreover, the user can complete the user control processing, by clicking the OK button, when the registered content is correct.

b) Homepage Creation,

It is possible to shift from the initial page described above, or from other pages in this system to the homepage creation page. In this homepage creation page, each user can register detailed user control information such as own profile.

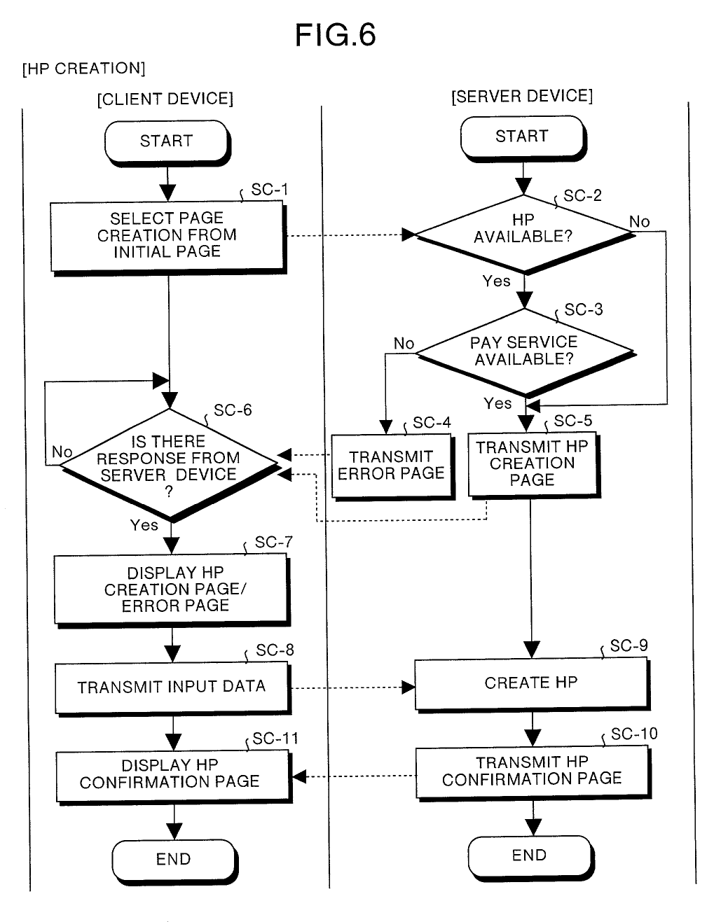

FIG. 6 is a flowchart showing the homepage creation processing. At first, when the user selects “page creation” from the initial page displayed on the client device 3, this matter is transmitted to the server device 2 (step SC-1).

The server device 1 accesses the WWW database 22 by the processing of the homepage creation section 50, to confirm if a homepage of the user who has requested the page creation has been already registered on the WWW database 22, and to check if the user has already created a homepage (step SC-2). In the case where the user has already created a homepage, the homepage creation section 50 accesses the user control information database 28, to check if the user who has requested page creation has made an agreement for pay service (step SC-3).

If there is no agreement made, the server device 1 transmits the error page for notifying that the user has registered a homepage but has not made an agreement for pay service, and hence update of the homepage cannot be done, with respect to the client device 3 (step SC-4). As a result, the error page is displayed on the client device 3 (steps SC-6, SC-7).

In the case where the user has not yet created a homepage, or there is an agreement for pay service, the homepage creation section 50 transmits the homepage creation page to the client device 3 in a method described below (step SC-5).

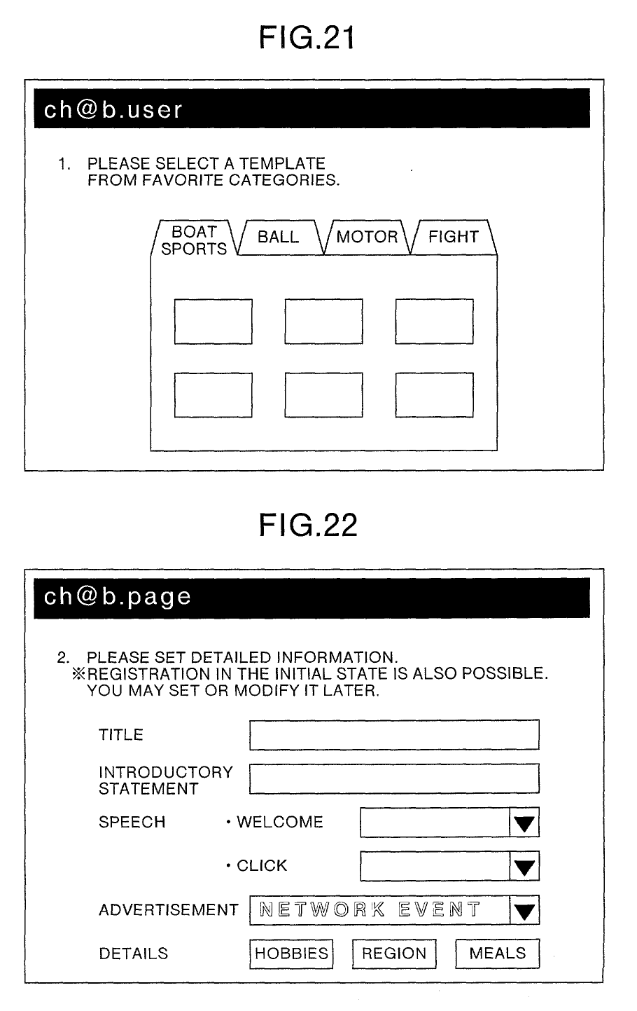

When the client device 3 receives the homepage creation page from the server device 1 (step SC-6), the homepage creation page is displayed on the display (step SC-7). FIG. 21 and FIG. 22 are diagrams showing one example of a display screen of the homepage creation page displayed on the display of the client device 3.

As shown in those figures, the category of the homepage, and detailed user control information such as profile information (gender, constellation, age, blood type, birthday, hobbies, special skill, address, twelve signs of the Oriental Zodiac, etc. of the user), game history information related to the user's game history, bulletin board, diary, calendar, etc. are input. Moreover, the user selects the advertising information to be displayed on the own homepage, from the list of advertising information displayed as a pull-down menu. Thereby, the user can select the advertising information to be displayed on the homepage according to his/her intention.

The selection of the advertising information may be selected automatically from the advertising information, based on the user information such as user's profile information, in the server device 1. For example, in the case where the user has an interest in sports game, the advertising information related to the sports game is selected so as to be displayed on the homepage of the user. Moreover, as in this embodiment, candidates of the advertising information are transmitted to the client device 3 of the user, and the user may select one from the candidates of the advertising information. For example, in the case where the user has an interest in sports game, a plurality of candidates of advertising information related to sports games are transmitted to the client device 3 of the user. Then, the user selects the advertising information to be displayed on the own homepage from the candidates.

When each user inputs own profile and the like in this homepage creation page via the input section of the client device 3, the client device 3 transmits the input information to the server device 1, together with the user ID of the user (step SC-8). Then, the user ID and the user control information such as user's profile and the like are stored in the user control information database 28, associated with each other. In registering the profile and the like, speech data and image data other than the text data can be registered, and for example, the speech data can be registered in the AIFF (Audio Interchange File Format) form, and the image data can be registered in the JPEG (Joint Photographic Experts Group) form. When the on-line URL locate list, the WWW URL locate list, the friends list or the rejection list, described later, is displayed, the user can freely invoke and refer to the profile and the like registered in this manner, by selecting a handle name displayed in each list.

The server device automatically creates a homepage based on the input information received from the client device 3, by the processing in the homepage creation section 50, and registers it in the WWW database 22 (step SC-9).

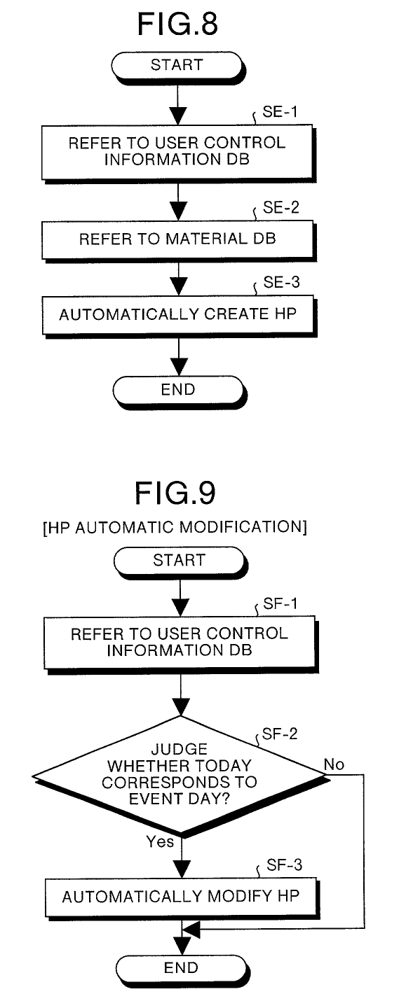

FIG. 8 is a flowchart showing the homepage automatic creation processing.

At first, the homepage creation section 50 in the server device 1 accesses the user control information database 28, based on the user ID in the input information received from the client device 3, to extract the user control information of this user (step SE-1). That is to say, the homepage creation section 50 extracts contents (bulletin board, diary, calendar, etc.) disclosed in the homepage, and personal information (mail address, telephone number, address, etc.) disclosed in the homepage, from the user control information database 28, to create “insert information” to be inserted in the homepage.

Then, the homepage creation section 50 accesses the material database 54, to refer to the material data of the homepage corresponding to the insert information inserted in the homepage, to thereby create the homepage (step SE-2) That is to say, in the case where the material data corresponding to respective insert information is registered in the material database 54, the insert information is converted to the material data, or is mixed with the material data, to thereby create the homepage. For example, as one example of conversion, in the case where there is the horoscope in the insert information, the homepage creation section 50 accesses the material database 54 based on the birthday of the user, to extract the horoscope information corresponding to this birthday, to thereby create the homepage. Moreover, for example, as one example of mixing, in the case where a diary is disclosed, the information related to the diary in the insert information is mixed with a predetermined diary format stored in the material database 54, to thereby create a diary homepage.

In the case where the insert information is a favorite game of the user, the homepage may be created by mixing the images of the game characters stored in the material database 54, or may be mixed so as to display the score of the game together.

In the case where link information related to the insert information is registered in the material database 54, the link information is mixed to create the homepage.

In the case where the material data corresponding to the insert information is not registered in the material database 54, the insert information is directly used to create the homepage. That is to say, for example, in the case where the insert information is a handle name of the user, the handle name is directly inserted into the homepage.

The homepage creation section 50 registers the created homepage in the WWW database 22 (step SE-3). In this manner, the homepage is automatically created based on the insert information extracted from the user control information database 28, and the material data of the homepage corresponding to these insert information. In addition, a pattern of a homepage may be registered in the material database, and this pattern may be changed based on the input information or the like to thereby create a homepage. Alternatively, a plurality of patterns may be registered, and a homepage may be created by a pattern selected by the user. Thereby, the homepage automatic creation processing is completed.

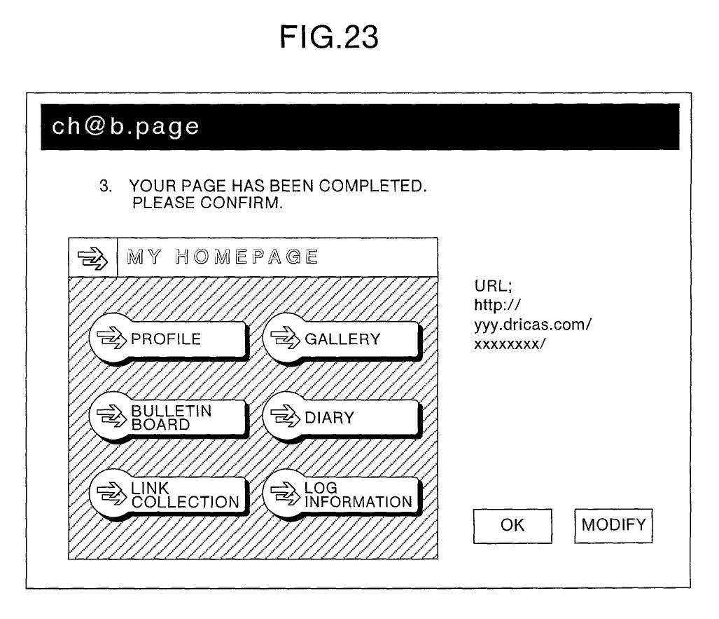

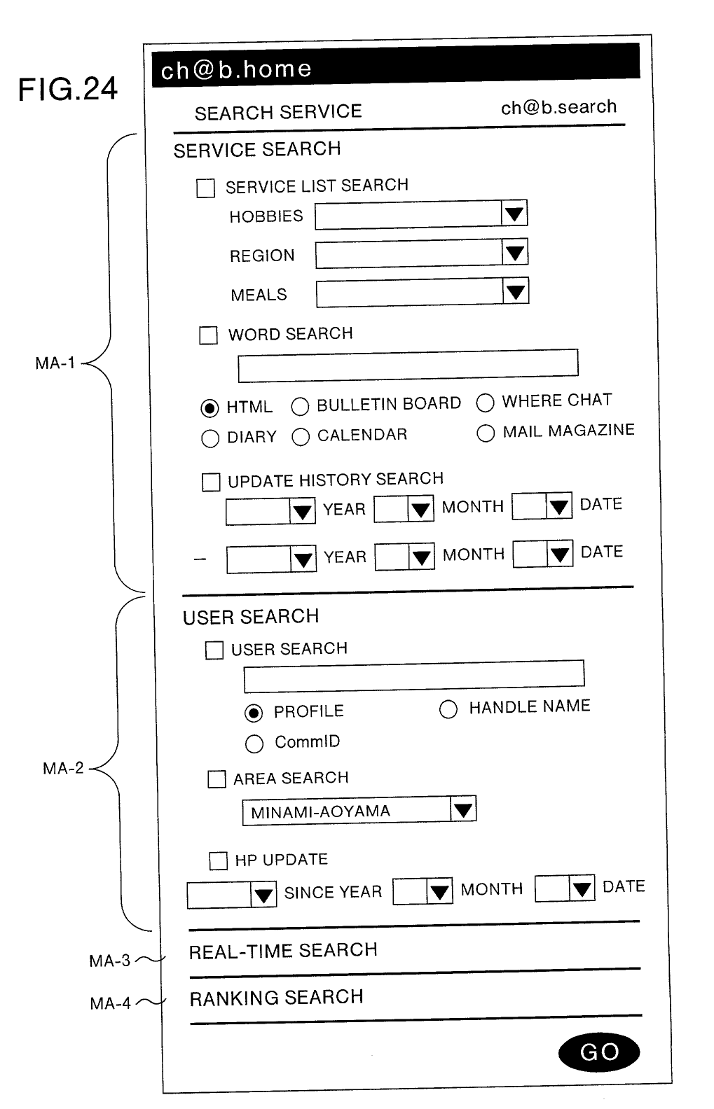

The server device 1 transmits a homepage confirmation page including the created homepage to the client device 3 (step SC-10). Thereby, the homepage confirmation page is displayed on the display of the client device 3 (step SC-11). FIG. 23 is a diagram showing one example of the display screen of the homepage confirmation page displayed on the display of the client device 3. As shown in this figure, the contents of the created homepage and the address are displayed. As a result, the homepage creation processing is completed.

c) Homepage Search,

It is possible to shift from the above-described initial page or from other pages in this system to a homepage search page. In this homepage search page, each user can search the user control information such as profiles or the like of other people.

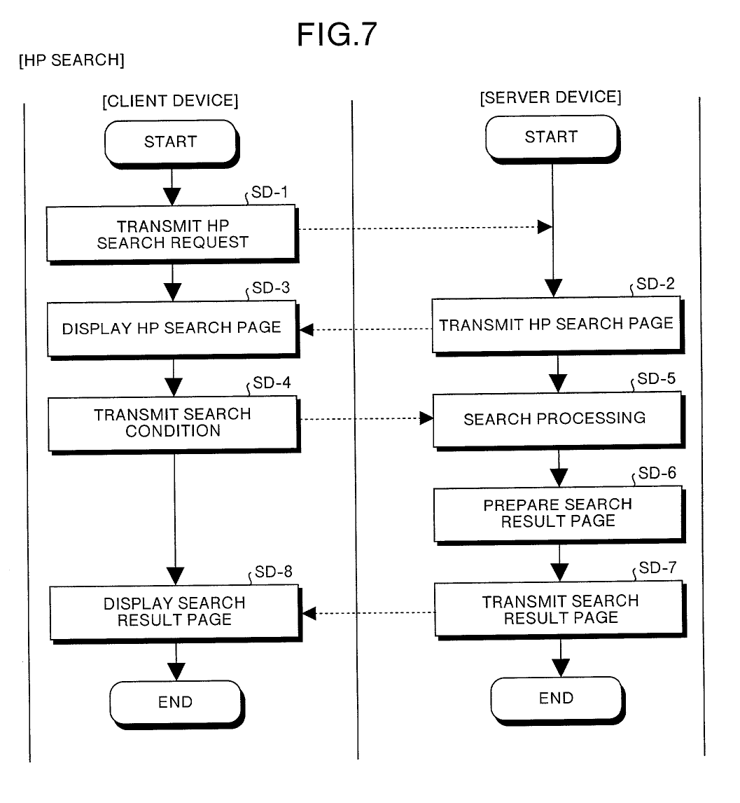

FIG. 7 is a flowchart showing the homepage search processing. At first, when a user selects “page search” from the initial page or the like displayed on the client device 3, the server device 1 extracts the homepage search page from the WWW database 22 and transmits this page to the client device 3 by the processing of the homepage search section 51 (step SD-1, step SD-2). Thereby, the homepage search page is displayed on the display of the client device 3 (step SD-3). FIG. 24 is a diagram showing one example of the display screen of the homepage search page displayed on the display of the client device 3. As shown in this figure, the display screen of the homepage search page comprises, for example, an input box MA-1 for inputting the service search conditions, an input box MA-2 for inputting the user search conditions, a button MA-3 for selecting real-time search, and a button MA-4 for selecting ranking search.

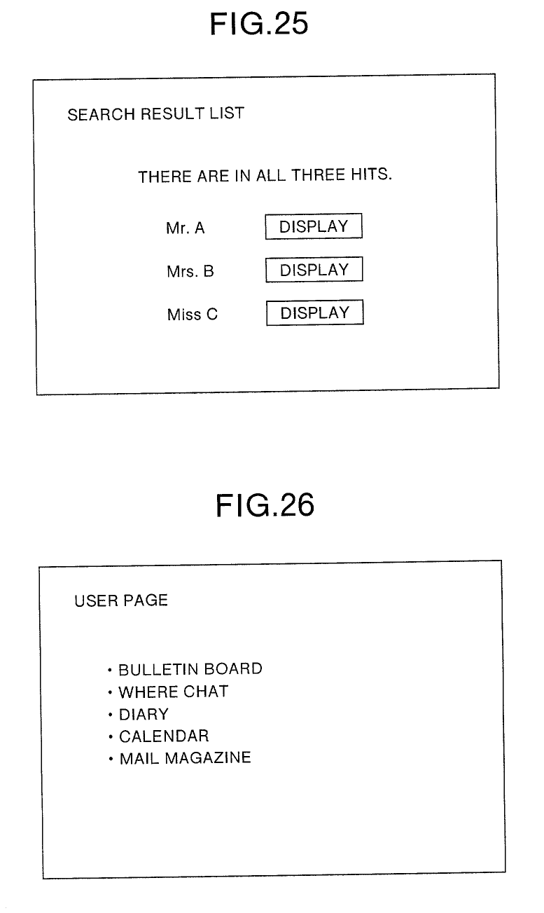

The client device 3 transmits the search condition or the like input by the user to the server device 1 (step SD-4). The homepage search section 51 extracts users coinciding with the search condition, referring to the user control information database, based on the received search condition or the like (step SD-5), to prepare a search result page (step SD-6). The server device 1 transmits this search result page to the client device 3 (step SD-7), thereby the client device 3 displays the search result page on the display (step SD-8). FIG. 25 is a diagram showing one example of the display screen of the search result page displayed on the display of the client device 3. As shown in this figure, the search results are displayed, and from these results, a homepage of a desired user can be displayed. FIG. 26 is a diagram showing one example of the display screen of the user's homepage displayed on the display of the client device 3.

d) Homepage Automatic Modification,

The thus created homepage can be automatically modified in accordance with a predetermined condition, for example, an event decided beforehand, such as the user's birthday, wedding anniversary, etc.

FIG. 9 is a flowchart showing the homepage automatic modification processing. At first, the server device 1 refers to the user control information database 28, by the processing of the homepage automatic modification section 52, to confirm whether or not today corresponds to a predetermined condition, for example, the event decided beforehand, such as the user's birthday, wedding anniversary, etc. (step SF-1). That is to say, the homepage automatic modification section 52 obtains the today's date from the system clock in the server device 1, and judges whether or not the day corresponds to the event decided beforehand, such as the user's birthday, wedding anniversary, etc. registered in the user control information database 28.

On the other hand, the homepage automatic modification section 52 in the server device 1 obtains the access history with respect to the user's homepage, using the existing technique, to thereby confirm whether this access history corresponds to a predetermined condition or not. That is to say, it is judged whether the access history is less than a predetermined threshold or exceeds the predetermined threshold.

When the homepage automatic modification section 52 judges that the access history coincides with the above-described predetermined condition, the material of the homepage corresponding to the predetermined condition is extracted, and the homepage is modified using this material (step SF-2, step SF-3). For example, in the case where the access history is less than the predetermined threshold, the homepage automatic modification section 52 obtains material data such as mold and moss from the material database 54, to thereby darken the homepage design little by little, and to automatically modify the homepage to a moldy and mossy design. In the case where the access history exceeds the predetermined threshold, the homepage automatic modification section 52 obtains material data of a star mark corresponding to the number of accesses, to automatically modify the homepage to a design displaying star marks corresponding to the number of accesses in the homepage (for example, one star mark is added per 10,000 accesses).

In the case where today corresponds to the predetermined condition, for example, an event decided beforehand, such as user s birthday or wedding anniversary, the homepage automatic modification section 52 obtains the material data corresponding to the predetermined event from the material database 54, to thereby automatically modify the homepage design to the one using the obtained material data.

e) On-Line URL Location,

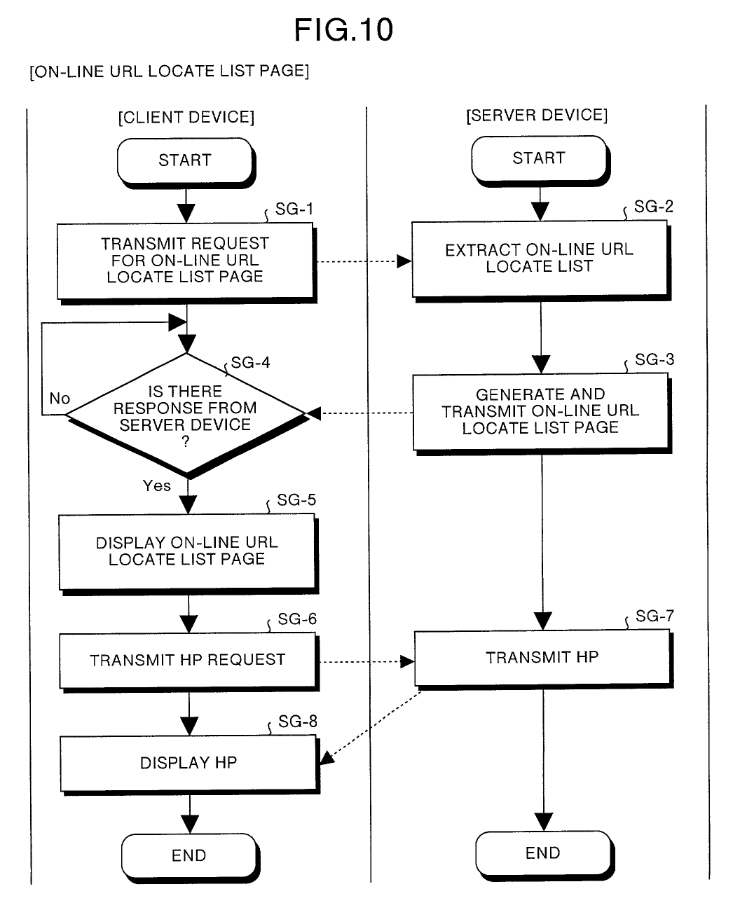

It is possible to shift from the initial page described above, or from other pages in this system to the on-line URL locates page. FIG. 10 is a flowchart showing the display processing of this on-line URL locate page. This on-line URL locate page is prepared and updated by the matching section 13, and stored in the matching section 21. Then, as shown in FIG. 10, when there is a request from the client device 3 (step SG-1), the on-line URL locate list stored in the matching information storage section 21 is extracted at this point of time (step SG-2), and a on-line URL locate page 2 is generated using this list (step SG-3), and transmitted to the client device 3 and displayed thereon (step SG-4, step SG-5).

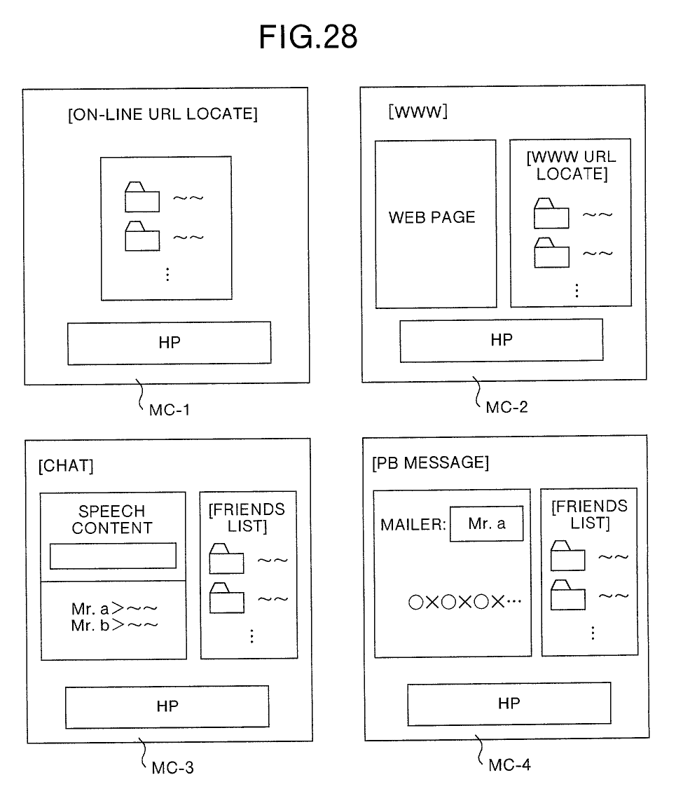

It is possible to shift from the on-line URL locate list displayed in this manner to the homepage. That is to say, when a homepage is requested from the on-line URL locate list by the client device 3, the server device 1 extracts the corresponding homepage from the WWW database 22, and transmits the homepage to the client device 3 (step SG-6, step SG-7). Thereby, the client device 3 can display a desired homepage (step SG-8). MC-1 in FIG. 28 is a diagram showing one example of the display screen for displaying a Web page from the on-line URL locate displayed on the display of the client device 3.

MB-3 in FIG. 27 shows a configuration example of the on-line URL locate list. In this figure, in the on-line URL locate list, images of a plurality of folders F1 to F3 are arranged vertically, and names of the folders FN1 to FN3 are shown on the side of each image. Each folder is prepared by hierarchization of the above-described matching section 13, and associated with a handle name of a predetermined number (for example, for 50 people). By selecting an optional folder F1 to F3 (in this figure, folder F3) via the input unit 35, by clicking or the like, the plurality of handle names HN associated with the corresponding folders F1 to F3 are displayed. As a matter of course, these images, the arrangement and the like show one example only, and the same function as the above folder can be achieved by using an optional image such as circle, star, or the like, other than these. By clicking the handle name HN displayed in this manner, the homepage corresponding to the handle name can be displayed, as described above.

f) Display of WWW URL Locate List,

In this WWW, the WWW URL locate list can be displayed automatically, or under a predetermined instruction by the user. MB-4 in FIG. 27 shows the configuration example of the WWW URL locate list. In this figure, the WWW URL locate list is constructed substantially similarly to the on-line URL locate list in MB-3 in FIG. 27.

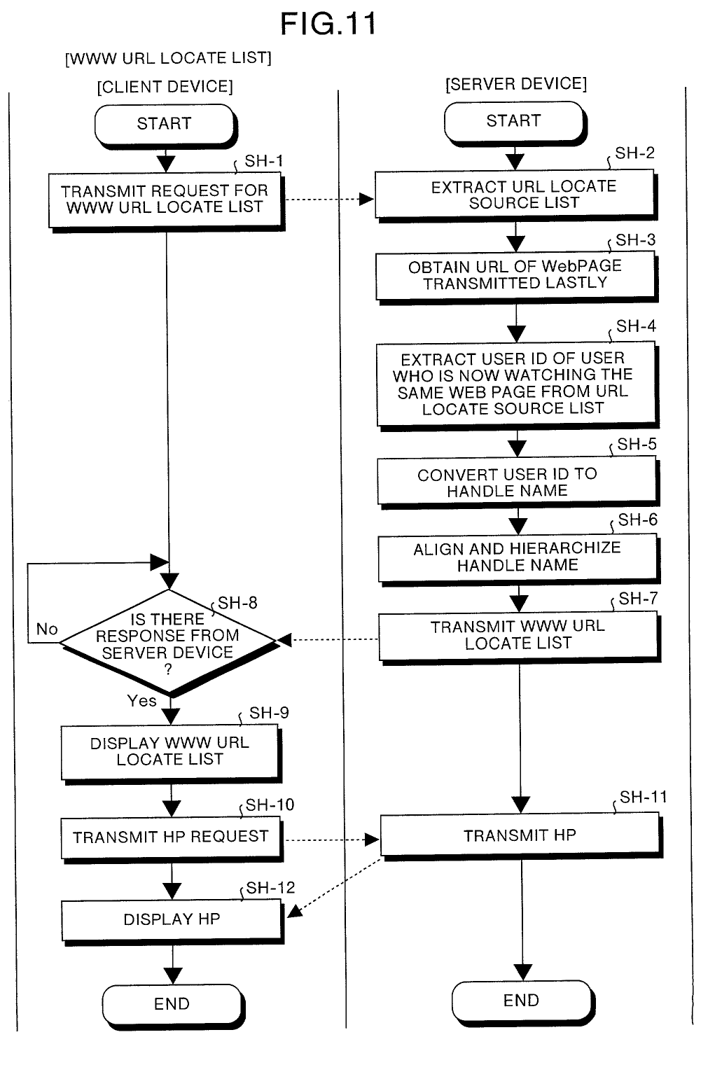

FIG. 11 is a flowchart showing preparation and update processing of the WWW URL locate list. This WWW URL locate list is displayed by obtaining necessary information from the URL locate source list in the connection information storage section 20, based on the URL of the Web page lastly transmitted to each client device 3. That is to say, when there is a transmission request of the WWW URL locate list, together with the user ID of each client device 3 (step SH-1), the URL locate source list stored in the matching information storage section 21 is extracted at this point of time (step SH-2). Then, based on the user ID of the client device 3 which has requested transmission, the URL of the Web page lastly transmitted to this client device 3 is obtained from the URL locate source list (step SH-3).

Based on this URL, the user IDs of other users who are watching the same Web page are extracted from the URL locate source list (step SH-4). This user ID is converted to a handle name by the processing of the ID conversion section 12 (step SH-5). The handle name thus converted is aligned and hierarchized in accordance with predetermined criteria by the processing of the matching section 13 (step SH-6), and transmitted to the client device 3 and displayed thereon as the WWW URL locate list (steps SH-7 to SH-9).

It is possible to shift from the thus displayed WWW URL locate list to the homepage. That is to say, when a homepage is requested from the WWW URL locate list by the client device 3, the server device 1 extracts the corresponding homepage from the WWW database 22, and transmits the homepage to the client device 3 (step SH-10, step SH-11). Thereby, the client device 3 can display the desired homepage (step SH-12). MC-2 in FIG. 28 is a diagram showing one example of the display screen of a Web page in which a desired homepage is displayed from the WWW URL locate displayed on the display of the client device 3.

g) Preparing and Updating Friends List/Rejection List,

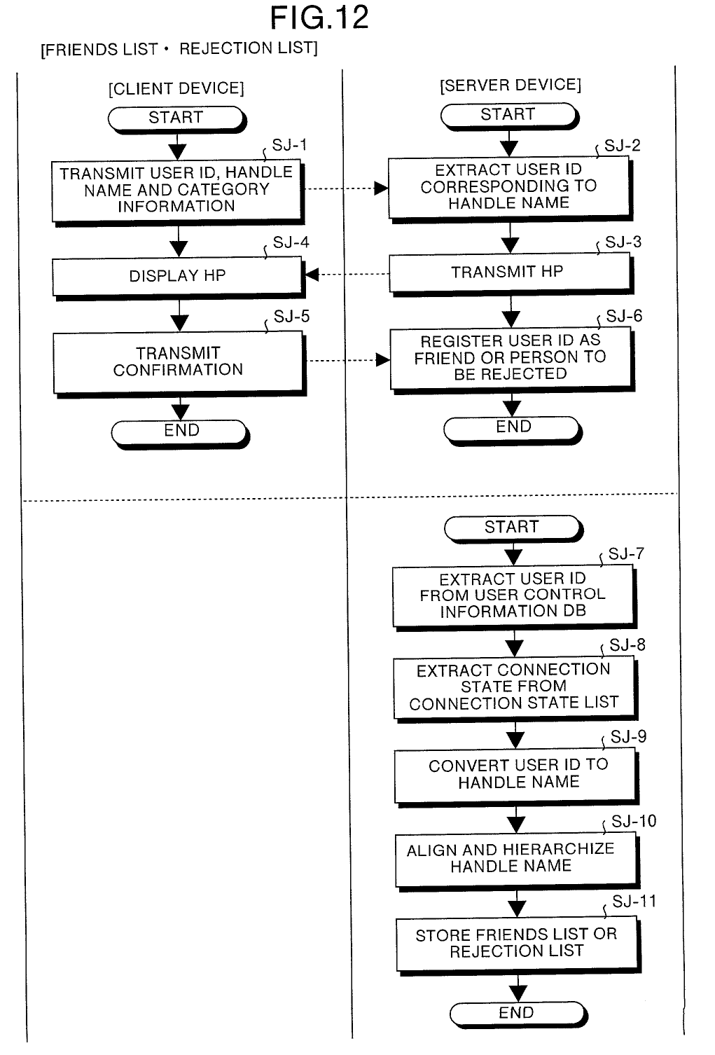

The processing for preparing and updating the friends list or the rejection list will be described. FIG. 12 is a flowchart showing preparation and update processing of the friends list or the rejection list. The preparation and update of these lists can be performed, using the on-line URL locate list or the WWW URL locate list. Specifically, each user selects an optional handle name in these lists, in the state with these friends list or the rejection list being displayed on the monitor, and instructs “add to the friends list” or “add to the rejection list”, by a pull-down menu or the like. Then, the user ID of the user who has made this instruction, the selected handle name, and the category information for discriminating between the friends list and the rejection list are transmitted to the server device 1 (step SJ-1).

The server device 1 extracts the user ID of an other user corresponding to the handle name transmitted from the client device 3 from the user control information database 28, by the processing of the authentication processing section 16 (step SJ-2). Moreover, the server device 1 accesses the WWW database 22 based on the user ID, and in the case where there is a homepage corresponding to this user ID, transmits this homepage to the client device 3 (step SJ-3) Thereby, the homepage is displayed on the display of the client device 3 (step SJ-4), and the user can confirm the person to be registered (step SJ-5). Then, this extracted user ID is registered in the user control information database 28 as a friend or as a person to be rejected, associated with the user ID transmitted from the client device 3, and in accordance with the category information (step SJ-6).

Thereafter, when there is a transmission request of the friends list or the rejection list from the client device 3, the user ID of the user registered as a friend or as the person to be rejected in the user control information database 28 is extracted (step SJ-7). Moreover, the connection state of the user ID extracted in this manner is extracted from the connection state list (step SJ-8). The user ID extracted in step SJ-7 is converted to a handle name in the ID conversion section 12 (step SJ-9), and this handle name is aligned and hierarchized in accordance with the predetermined criteria by the matching section 13 (step SJ-10).

By adding the connection state extracted in step SJ-8 to the handle name aligned in this manner, the friends list or the rejection list is prepared and updated, and stored in the matching information storage section 21 (step SH-11). The friends list or the rejection list prepared in this manner is invoked from this matching information storage section 21, when there is a transmission request from the client device 3 at an optional timing, and displayed on the monitor of the client device 3.

In MB-5 of FIG. 27, one example of the friends list is shown. In this friends list, the handle name of the user registered as a friend is hierarchized using a folder. Also, on the side of the handle name, status marks M1 to M3 indicating the connection state of the client device 3 corresponding to the handle name are displayed. When the status marks M1 to M3 are lighted, it shows the connection state is on-line, and when the status marks M1 to M3 are put out, it shows the connection state is off-line (in MB-5 of FIG. 27, only M1 and M2 are lighted). As a matter of course, the display method of such a connection state is optional. The user can display the homepage corresponding to the handle name as described above, by clicking the handle name displayed in this manner.

h) Chat,

The chat will be described. The chat available in this system includes chat between users displayed in the on-line URL locate list and the WWW URL locate list (URL chat), chat between users displayed in the friends list (friend chat), and chat between unspecified users unrelated to these lists (unspecified chat).

The unspecified chat can be basically performed in the same manner as the conventional chat. That is to say, a chat room already established by specifying an URL or specifying a menu is selected, to join this chat room for having a talk.

The URL chat and the friend chat can be performed in the similar manner, with an exception that the selection method of the chat candidate is different. That is to say, in the case of performing the URL chat, the chat partner can be selected from the on-line URL locate list and the WWW URL locate list, and in the case of performing the friend chat, the chat partner can be selected from the friend list.

i) Friend Chat,

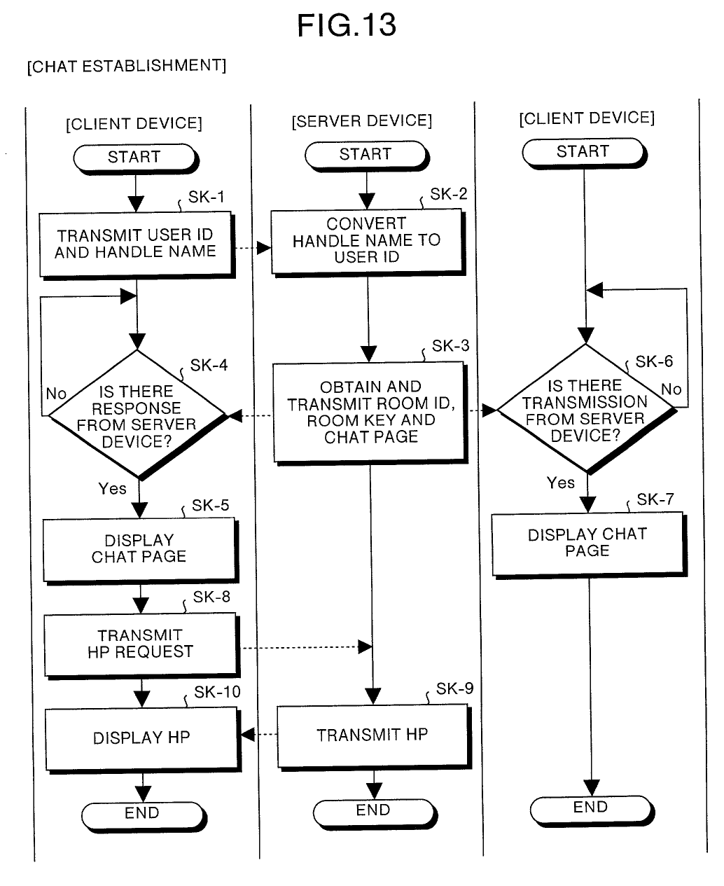

The case of performing the friend chat will now be described as an example. FIG. 13 is a flowchart showing the establishment processing of the friend chat. In the case where the friends list is displayed on the monitor of the client device 3, when anon-line handle name is optionally selected of the handle names displayed in this friends list, and establishment of the chat is requested, the user ID of the user of the client device 3 and the selected handle name are transmitted to the server device 1 (step SK-1). Then, in the server device 1, chat establishment is processed by the chat processing section 18. That is to say, the handle name selected in the ID conversion section 12 is converted to the user ID (step SK-2), and a room ID and a room Key for establishing the chat are obtained from the chat database 24. A chat page is also obtained from the WWW database 22. This chat page can be obtained by adding the handle name of the user to whom the chat page is transmitted, to thereby generate a new page.

The room ID, the room Key and the chat page obtained in this manner are transmitted to the client device 3 which has requested the chat establishment and the client device 3 corresponding to the user ID converted in the ID conversion section 12 (step SK-3). In the client device 3, when the chat page is transmitted, the chat page is interpreted via the HTML interpretation section 39, and displayed on the monitor (step SK-4 to step SK-7). That is to say, for the user of the client device 3, the chat page is suddenly displayed on the monitor of the own client device 3. Therefore, this user can actively have a talk with that user.

It is possible to shift from the chat page displayed in this manner to the homepage. That is to say, when a homepage of a desired chat partner is requested by the client device 3, from the chat page, the server device 1 extracts a corresponding homepage from the WWW database 22 and transmits this homepage to the client device 3 (step SK-8 and step SK-9). Thereby, the client device 3 can display a desired homepage (step SK-10). MC-3 in FIG. 28 is a diagram showing one example of the display screen of a Web page in which the homepage of the desired chat partner is displayed from the chat page displayed on the display of the client device 3. As shown in this figure, during chatting, when the handle name of the chat partner or the handle name in the friends list is clicked, the homepage of the corresponding user is displayed.

i) Executing PB Message,

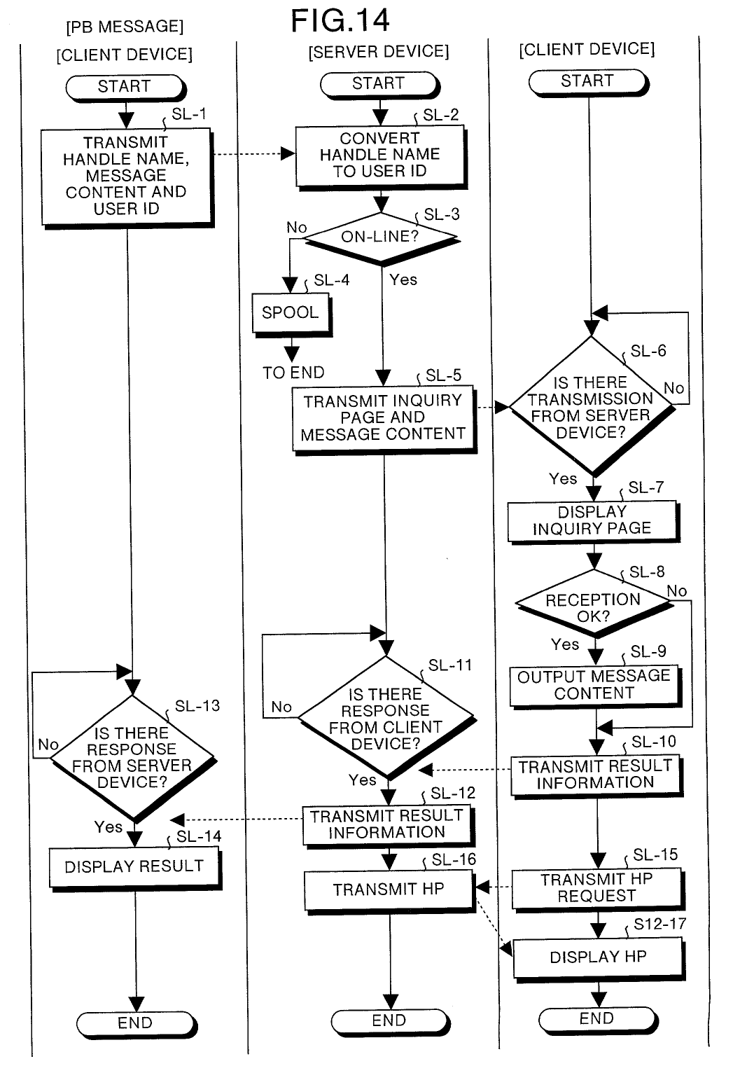

Lastly, the processing for executing the PB message will be described. FIG. 14 is a flowchart showing the execution processing of the PB message. In order to transmit this PB message, it is necessary to select the destination, and this selection can be performed using the on-line URL locate list, the WWW URL locate list or the friends list. For example, in the state that the chat page and the friends list are displayed on the monitor of the client device 3A, if a user selects a handle name of a person to whom the user wants to send a PB message, from the handle names displayed in the friends list, and requests transmission of the PB message, this request is processed in the PB message transfer section 40.

By the processing of this PB message transfer section 40, the page for inputting a message is first displayed on the monitor of the client device 3A. This input page comprises at least an input box for inputting the message contents. When a user “a” inputs the message contents in this input box, and instructs transmission, the message contents, the handle name already selected, and the user ID of the user “a” are transmitted to the server device 1 (step SL-1). The message contents are not limited to the text data, and may be prepared as image data or speech data.

In the server device 1, the transmitted handle name is converted to the user ID by the processing of the ID conversion section 12 (step SL-2). Then, the connection state of a client device 3B corresponding to the converted user ID is judged by the processing of the PB message processing section 19, by referring to the connection state list stored in the connection information storage section 20 (step SL-3). In the case of off-line, the user ID and the message content are spooled in the PB message database 26, associated with each other (step SL-4), and the processing is completed. The message in this case is transmitted, when there is an inquiry if there is a spool message or not, from the client device 3B by specifying the user ID.

On the other hand, in the case of on-line in step SL-3, an inquiry page for inquiring if the message is acceptable or not, and the message contents are transmitted to the client device 3B corresponding to the converted user ID (step SL-5). In the client device 3B having received these, at first only the inquiry page is displayed (step SL-6, step SL-7), and hence, the user inputs if the reception is acceptable or not. Only in the case where reception acceptable is input, the message content is output on the monitor or by a speaker (step SL-8, step SL-9). Then, the information showing the result of this reception available or not is transmitted to the server device 1 (step SL-10). This information is transmitted to the client device 3A via the server device 1 and displayed thereon (step SL-11 to step SL-14).

It is possible to shift from the PB message page displayed in this manner to the homepage. That is to say, when a homepage of a desired person to whom the PB message is to be transmitted is requested by the client device 3, from the PB message page, the server device 1 extracts the corresponding homepage from the WWW database 22 and transmits this homepage to the client device 3 (step SL-15 and step SL-16). Thereby, the client device 3 can display a desired homepage (step SL-17).

MC-4 in FIG. 28 is a diagram showing one example of the display screen of a Web page in which the homepage of the desired person to whom the PB message is to be transmitted is displayed from the PB message page displayed on the display of the client device 3. As shown in this figure, when the handle name of the person to whom the PB message is to be transmitted or the handle name in the friends list is clicked during transmission of the PB message, the homepage of the corresponding user is displayed. Thereby, the transmission processing of the PB message is completed.

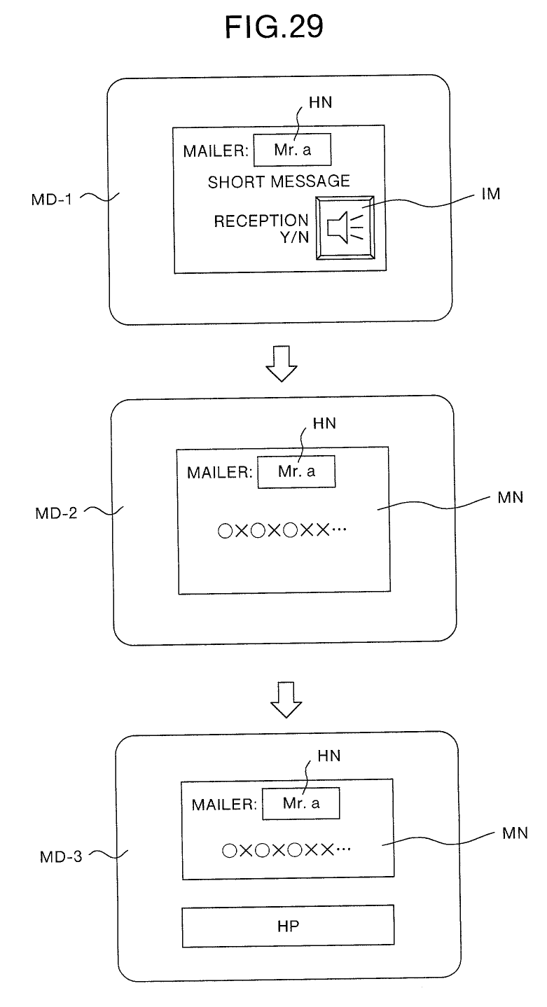

FIG. 29 shows a display example of the inquiry page and the PB message page. At first, as shown in MD-1 in FIG. 29, in the inquiry page, there are displayed the handle name HM of the mailer and characters of “Reception Y/N” as the input section for inputting reception acceptable or not. Moreover, in the case where there are message contents by speech or image, an image IM indicating this matter is displayed. Then, the receiver can input the above-described reception available or not by selecting “Y” or “N” by clicking or the like. Alternatively, in the case of clicking the image IM, it is assumed that reception acceptable has been input.

In the case where reception acceptable has been input, the PB message in MD-2 of FIG. 29 is displayed. In this page, the handle name HM of the mailer and the message content MN are displayed. In the case where there is a speech message, the speech message is output from the speaker together with the message content MN, instead of the message content.

In the case where the user clicks the handle name of the mailer by the input unit of the client device 3, a page including the homepage in MD-3 of FIG. 29 is displayed. In this page, the homepage of the mailer is displayed in addition to the above-described information.

One embodiment of the present invention is described above, however, the present invention may be executed in various different embodiments in the range of technical thought described in the claims described below, other than the above-described embodiment.

For example, in the above-described embodiment, the update authority of the homepage has been described for a case where the update authority thereof is provided, when the user makes an agreement for the pay service. However, the present invention is not limited to this case, and in other embodiments, for example, it may be provided to users whose number of accesses, an amount of information provided, scores in the game, or the like exceeds a predetermined threshold.

Of the respective processing described in the embodiment, the whole processing or a part of the processing described as being performed automatically may be performed manually. Alternatively, the whole processing or a part of the processing described as being performed manually may be performed automatically by a known method.

Besides the above, information including parameters such as the processing procedures, the control procedures, the specific names, various registered data, the retrieval conditions or the like, the screen examples, and the database configuration may arbitrarily be modified except for an special instruction.

Each constituent shown in the figure is functionally conceptual, and is not necessarily required to be physically constituted as shown in the figure.

For example, of each processing function of the server device 1, the whole or an optional part thereof maybe realized by a CPU (Central Processing Unit) and by a program interpreted and executed by the CPU, or may be realized as hardware by means of a wired logic.

The connection information storage section 20 and the matching information storage section 21 may be constructed by an optional regrettable memory, for example, a RAM (Random Access Memory) or a hard disk (HD).

The specific form of dispersion and integration of the server device 1 is not limited to the one shown in the figure, and the whole or a part thereof may be dispersed or integrated functionally or physically, in an optional unit corresponding to various loads. For example, dispersion may be performed such that a portion related to a function of providing a Web page is designated as a WWW server, a portion related to the chat function is designated as a chat server, a portion related to the PB message function is designated as a message server (mail server), and a portion related to the user information control function of the client device 3 is designated as a database server, and the above-described server device 1 can be realized as a whole server group. In the case where the server device 1 is constructed in such a decentralized structure, each constituent can be connected communicably via an optional network such as LAN (local Area Network) or WAN (Wide Area Network). Actually, functions of a fire wall server and a DNS (Domain Name System) server are added as a function of constituting the server device 1, but these can be constructed in the conventional manner, hence the description thereof is omitted.

With regard to the server device 1 and the client device 3, each constituent shown in the figure is functionally conceptual, and it is not necessarily required to be physically constructed as shown in the figure.

For example, with regard to the processing function of the server device 1, in particular, each processing function performed in the control section, the whole or an optional part thereof may be realized by a CPU (Central Processing Unit) and by a program interpreted and executed by the CPU, or may be realized as hardware by means of the wired logic. The program is stored in a recording medium (not shown), and read mechanically according to need.

The server device 1 may also comprise an input unit (not shown) comprising various pointing devices such as a mouse, a keyboard, an image scanner and a digitizer, a display unit (not shown) used for monitoring the input data, a clock generation section (not shown) for generating the system clock, and an output unit (not shown) such as a printer for outputting various processing results and other data. The input unit, the display unit and the output unit may be connected to the control section, respectively, via an input/output interface.

Various database is a memory such as RAM and ROM, a fixed disk unit such as a hard disk, and storage unit such as a flexible disk and an optical disk, which store various programs used for various processing and for providing a Web site, tables, files, database and files for Web pages.

The server device 1 may be realized by connecting peripheral equipment such as a printer, a display and an image scanner to the information-processing unit such as an information-processing terminal, for example, a well known personal computer or work station, and implementing software (including programs and data) for making the information-processing unit realize the method of the present invention.

The specific form of dispersion and integration of the server device 1 is not limited to the one shown in the figure, and the whole or a part thereof may be functionally or physically dispersed or integrated in an optional unit corresponding to various loads. For example, the respective database may be constituted independently as an independent database unit, or a part of the processing may be realized by using a CGI (Common Gateway Interface).

The client device 3 may be realized by connecting peripheral equipment such as a printer, a display and an image scanner to the information-processing unit such as an information-processing terminal, for example, a well known personal computer, work station, home game unit, Internet TV, PHS terminal, portable terminal, mobile communication terminal or PDA, according to need, and implementing software (including programs and data) for making the information-processing unit realize the browsing function of the Web information and the e-mail function.

The whole or an optional part of the control section of the client device 3 can be realized by a CPU and a program interpreted and executed by the CPU. That is to say, in the ROM or HD, there is stored a computer program for giving an instruction to the CPU in cooperation with the OS (Operating System) to perform various processing. This computer program is loaded into the RAM and executed, and constitutes the control section in cooperation with the CPU.

However, this computer program may be stored in the application program server connected to the client device 3 via an optional network, and the whole or a part thereof may be downloaded according to need. Alternatively, the whole or a part thereof may be realized as hardware by means of the wired logic or the like.

The “computer-readable recording medium” includes optional “portable physical media” such as floppy disk, magneto-optical disk, ROM, EPROM, EEPROM, CD-ROM, MO and DVD, “fixed physical media” such as ROM, RAM and HD built in various computer systems, or “communication media” for holding the program for a short period of time, such as a communication line or a carrier wave in the case of transmitting the program via a network represented by LAN, WAN and the Internet.

The “program” is a method of data processing described in an optional language and description method, and any format of the source code and the binary code may be used. In addition, the “program” is not limited to the one constructed one and only, and may include the one dispersed as a plurality of modules or libraries, and the one that achieves the function in cooperation with a separate program represented by the OS (Operating System). In addition, with regard to the specific construction, the read procedure for reading the recording medium in each unit shown in the embodiment, or the install procedure after read, a known construction and procedure can be used.

The network 2 has a function of connecting the server device 1 with the client device 3, and for example, may include either one of the Internet, Intranet, LAN (including both wired and wireless communication), VAN, personal computer communication network, pay phone network (including both analog and digital), leased line network (including both analog and digital), CATV network, IMT 2000 method, portable circuit switched network and portable packet switched network such as GSM method or PDC/PDC-P method, radio paging network, local radio network such as Bluetooth, PHS network, and satellite communication network such as CS, BS or ISDM. That is to say, this system can transfer various data via an optional network, regardless of being wired or wireless.

As described above in detail, according to one aspect of the present invention, the input format for inputting the user information related to the user is transmitted to the information terminal, and user's homepage is created according to the user information transmitted from the information terminal. Hence, there can be provided a communication system, a communication information-processing unit, an information terminal, a communication method and a recording medium, in which the user can easily release the own profile information or the like in the homepage.

Also, according to another aspect of the present invention, the user information includes profile information related to the user profile, including at least one of the user ID, password, communication ID, nickname, gender, occupation, constellation, age, blood type, birthday, hobbies, special skill, address, region where the user lives, genre in which the user has an interest, hobbies, URL of own homepage, homepage name, and twelve signs of the Oriental Zodiac. Hence, based on these profiles, a homepage can be easily created.

According to still another aspect of the present invention, the user information includes at least one of the game history information related to the game history of the user, information related to the genre of the user's favorite game and information related to a character in the favorite game. Hence, a homepage can be easily created based on the game history or the like of the user.

According to still another aspect of the present invention, the user's homepage is created in accordance with the predetermined format, and hence, a homepage can be always created in a certain format, thereby making it convenient to search the homepage.

According to still another aspect of the present invention, the update authority information for judging whether the user can update the created homepage or not is stored, and the update authority information of the user is judged, and when the update is possible, the homepage is updated according to the request of the user. As a result, in order to update the homepage, it is necessary to obtain the update authority, thereby preventing the homepage from being updated unreasonably, and it leads to a contract of additional services for users who wants to have the originality in his homepage.

According to still another aspect of the present invention, the update authority information is set so that the homepage can be updated, when the user pays the counter value, and hence the update authority can be added with a charge.

According to still another aspect of the present invention, the created homepage is modified in accordance with the predetermined condition, and hence when there is an event such as birthday, the contents of the homepage are automatically updated.

According to still another aspect of the present invention, since the created homepage is modified, in accordance with the number of accesses to the homepage, a difference can be provided between a homepage with a few number of accesses and a homepage with lots of numbers of access, thereby providing an incentive to create a useful homepage.

According to still another aspect of the present invention, since the created homepage is modified, in accordance with the profile information, at the time of an event such as birthday, wedding anniversary, etc., this matter can be displayed, thereby providing an incentive to create a useful homepage.

According to still another aspect of the present invention, since predetermined search condition is received from the information terminal, and the homepage coinciding with the search condition is searched, it becomes possible to search a homepage of, for example, a user whose birthday is today. Hence, a homepage coinciding with a predetermined condition can be easily found.

According to still another aspect of the present invention, advertising information related to an advertisement is stored, and the advertising information to be displayed on the homepage is selected based on a predetermined condition from the stored advertising information, to thereby create a homepage including the selected advertising information. Hence, the homepage including the advertising information can be created, by automatically selecting the advertising information to be displayed on the homepage. Moreover, the selection of the advertising information can be done based on the profile information or the like appeared in the homepage.

According to still another aspect of the present invention, since the advertising information displayed in the homepage is selected from the stored advertising information, based on the condition requested from the information terminal of the user, the user can select the advertising information to be displayed on the own homepage, according to his/her own intention.

Furthermore, according to still another aspect of the present invention, a chat candidate, being a user who becomes a candidate of chat participants is selected based on predetermined criteria, and the user information of the chat candidate is transmitted to the information terminal. When there is a request of homepage by specifying at least a part of the chat candidates, the homepage of the specified chat candidate is transmitted to the information terminal which has issued the request. When there is a request of starting the chat by specifying at least a part of the chat candidates, the predetermined information for starting the chat is transmitted with respect to the information terminal of the specified chat candidate and the information terminal which has issued the request information. Hence, at the time of performing the chat, the homepage of the candidate can be easily accessed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A communication system comprising:
a communication information-processing unit; and a plurality of information terminal connected to said communication information-processing unit via a network, wherein users of said information terminals communicate with each other,
said communication information-processing unit including,
an input format transmission unit which transmits, to a particular one of said information terminal, an input format for inputting user information related to the user of said particular information terminal; and
a homepage creation unit which creates a homepage of the user of said particular information terminal based on the user information received from said particular information terminal, and
each one of said information terminals includes,
an input display unit which displays an input area for inputting the user information in the input format received from said communication information-processing unit.

2. The communication system according to claim 1, wherein said communication information-processing unit further comprises:
an update authority information storage unit which stores update authority information for judging whether or not the users of said information terminals are allowed to update their homepages; and
a homepage update unit which updates the homepage of particular user in accordance with a request from that particular user if the update authority information stored in said update authority information storage unit indicates that that particular user is allowed to update his homepage.

3. The communication system according to claim 1, wherein said communication information-processing unit further comprises a homepage modification unit which modifies the homepage when a predetermined condition is fulfilled.

4. The communication system according to claim 1,
wherein said communication information-processing unit further includes,
a matching unit which selects chat candidates, being the users who desire to participant in a chat, based on a predetermined criteria, and transmits the user information of all the chat candidates to said information terminal of each of the chat candidate; and
a homepage transmission unit which, when there is a request of the homepage from said information terminal by specifying at least a part of said chat candidate, transmits the homepage of said specified chat candidate to said information terminal which has issued the request; and
a chat processing unit which, when there is a request of starting the chat from said information terminal by specifying at least a part of said chat candidate, transmits predetermined information for starting the chat, with respect to said information terminal of said specified chat candidate and said information terminal which has issued the request, and
each one of said information terminals further include,
a user information display unit which displays an area for displaying the user information of said chat candidate, received from said communication information-processing unit;
a homepage display unit which displays an area for displaying the homepage received from said communication information-processing unit; and
a chat display unit which, when predetermined information for starting the chat is transmitted from said communication information-processing unit, displays the chat area based on the information.

5. A communication information-processing unit connected to a plurality of information terminals via a network, and constituting a communication system by which users of said information terminals communicate with each other, said communication information-processing unit comprising:
an input format transmission unit which transmits, to a particular one of said information terminal, an input format for inputting user information related to the user of said particular information terminal; and
a homepage creation unit which creates a homepage of the user of said particular information terminal based on the user information received from said particular information terminal.

6. The communication information-processing unit according to claim 5, wherein the user information includes profile information related to the user profile, including at least one of the user ID, password, communication ID, nickname, gender, occupation, constellation, age, blood type, birthday, hobbies, special skill, address, region where the user lives, genre in which the user has an interest, hobbies, URL of own homepage, homepage name, and twelve signs of the Oriental Zodiac.

7. The communication information-processing unit according to claim 5, wherein the user information includes at least one of the game history information related to a game history of the user, information related to a genre of the user's favorite game and information related to a character in a favorite game.

8. The communication information-processing unit according to claim 5, wherein said homepage creation unit creates the user's homepage in accordance with a predetermined format.

9. The communication information-processing unit according to claim 5, further comprising:
an update authority information storage unit which stores update authority information for judging whether or not the user is allowed to update his homepage; and
a homepage update unit which updates the user's homepage in accordance with a request from the user if the update authority information stored in said update authority information storage unit indicates that the user is allowed to update his homepage.

10. The communication information-processing unit according to claim5, further comprising an update authority information setting unit which sets the update authority information in such a manner that the user is allowed to update his homepage when he pays a particular amount of money.

11. The communication information-processing unit according to claim 5, further comprising a homepage modification unit which modifies the homepage when a predetermined condition is fulfilled.

12. The communication information-processing unit according to claim 5, wherein said homepage modification unit modifies the user's homepage depending on a number of accesses to the homepage.

13. The communication information-processing unit according to claim 5, wherein said homepage modification unit modifies the user's homepage depending on a profile information of the user.

14. The communication information-processing unit according to claim 5, comprising,
a search condition reception unit which receives a predetermined search condition from said information terminal; and
a homepage search unit which searches the homepage coinciding with the search condition, received by said search condition reception unit.

15. The communication information-processing unit according to claim 5, further comprising:
a matching unit which selects a chat candidate, being the user who becomes a candidate of the chat participant, based on predetermined criteria, and transmits the user information of said chat candidate to said information terminal;
a homepage transmission unit, when there is a request of the homepage from said information terminal by specifying at least a part of said chat candidate, which transmits the homepage of said specified chat candidate to said information terminal which has issued the request; and
a chat processing unit, when there is a request of starting the chat from said information terminal by specifying at least a part of said chat candidate, which transmits predetermined information for starting the chat, with respect to said information terminal of said specified chat candidate and said information terminal which has issued the request.

16. The communication information-processing unit according to claim 5, further comprising:
an advertising information storage unit which stores advertising information related to an advertisement; and
an advertises information selection unit which selects the advertising information to be displayed on the homepage, based on a predetermined condition, from the advertising information stored in said advertising information storage unit,
wherein said homepage creation unit creates a homepage including the advertising information selected by said advertising information selection unit.

17. The communication information-processing unit according to claim 16, wherein said advertising information selection unit selects the advertising information to be displayed on the homepage, from the advertising information stored in said advertising information storage unit, based on a condition requested from the user.

18. An information terminal connected to a communication information-processing unit via a network, and constituting a communication system by which users of each information terminal communicate with each other under control of said communication information-processing unit, said information terminal comprising:
an input display unit which displays an input area for inputting the user information in an input format received from said communication information-processing unit; and
a transmission unit which transmits the user information, input by the user in the input area displayed by said input display unit, to said communication information-processing unit.

19. The information terminal according to claim 18, further comprising:
an user information display unit which displays an area for displaying the user information of a chat candidate, being the user who becomes a candidate of the chat participant, received from said communication information-processing unit;
a homepage request unit which requests the homepage of the specified chat candidate to said communication information-processing unit, by specifying at least a part of said chat candidate;
a homepage display unit which displays the area to display the homepage received from said communication information-processing unit; and
a chat display unit which, when predetermined information for starting the chat is transmitted from said communication information-processing unit, displays the chat area based on this information.

20. A communication method by which users of a plurality of information terminals communicate with each other via a communication information-processing unit connected to a network, in the communication method said communication information-processing unit executing:
transmitting, to a particular one of said information terminal, an input format for inputting user information related to the user of said particular information terminal; and
creating a homepage of the user of said particular information terminal based on the user information received from said particular information terminal.

21. The communication method according to claim 20, wherein the user information includes profile information related to the user profile, including at least one of a user ID, password, communication ID, nickname, gender, occupation, constellation, age, blood type, birthday, hobbies, special skill, address, region where the user lives, genre in which the user has an interest, hobbies, URL of own homepage, homepage name, and twelve signs of the Oriental Zodiac.

22. The communication method according to claim 20, wherein the user information includes at least one of a game history information related to a game history of the user, information related to a genre of the user's favorite game and information related to a character in a favorite game.

23. The communication method according to claim 20, wherein the user's homepage is created in a predetermined format.

24. The communication method according to claim 20, further comprising:
storing an update authority information for judging whether or not the user is allowed to update his homepage; and
updating the user's homepage in accordance with a request from the user if the stored update authority information indicates that the user is allowed to update his homepage.

25. The communication method according to claim 20, wherein the update authority information is set in such a manner that the user is allowed to update his homepage when he pays a particular amount of money.

26. The communication method according to claim 20, further comprising modifying the user's homepage when a predetermined condition is fulfilled.

27. The communication method according to claim 20, wherein the user's homepage is modified depending on a number of accesses to the homepage.

28. The communication method according to claim 20, wherein the user's homepage is modified depending on the profile information of the user.

29. The communication method according to claim 20, comprising,
receiving search condition(s) from said particular information terminal; and
searching a homepage coinciding with the received search condition(s).

30. The communication method according to claim 20, further comprising:
selecting chat candidates, being the users who desire to participant in a chat, based on a predetermined criteria, and transmits the user information of all the chat candidates to said information terminal of each of the chat candidate;
transmitting, when there is a request of the homepage from said information terminal by specifying at least a part of said chat candidate, the homepage of said specified chat candidate to said information terminal which has issued the request; and
transmitting, when there is a request of starting the chat from said information terminal by specifying at least a part of said chat candidate, predetermined information for starting the chat with respect to said information terminal of said specified chat candidate and said information terminal which has issued the request.

31. The communication method according to claim 20, further comprising:
storing advertising information related to an advertisement; and
selecting the advertising information to be displayed on the homepage, based on a predetermined condition, from the stored advertising information,
wherein the user's homepage that includes the selected advertising information is created.

32. The communication method according to claim 31, wherein in the advertising information selection step, the advertising information displayed in the homepage is selected from the stored advertising information, based on a condition requested from said particular information terminal.

33. A computer-readable recording medium for storing a computer program, which when executed on a computer, causes the computer to realize a communication method by which users of a plurality of information terminals communicate with each other via a communication information-processing unit connected to a network, in the computer program making said communication information-processing unit execute:
transmitting, to a particular one of said information terminal, an input format for inputting user information related to the user of said particular information terminal; and
creating a homepage of the user of said particular information terminal based on the user information received from said particular information terminal.
